(19) United States
(12) Patent Application Publication
(10) Pub. No.: US 2026/0365792 A1
(43) Pub. Date: Nov. 19, 2026

(54) Functional Diphenylsulfone Macromers with Grafted Polymeric Sidechains Plus Copolymers and Articles Prepared Therefrom

(71) Applicant: Thermo Fisher Bioprocessing Inc., Waltham, MA (US)

(72) Inventors: George W. Griesgraber, Eagan, MN (US); Gabriel Guerra Faura, Waltham, MA (US); David Scott Hays, Waltham, MA (US); Jonathan F. Hester, Hudson, WI (US); Austin Kruger, Waltham, MA (US); Lucas D. McIntosh, Minneapolis, MN (US)

(21) Appl. No.: 19/488,975

(22) PCT Filed: May 30, 2024
(86) PCT No.: PCT/IB2024/055287

§ 371 Date: Dec. 1, 2025

Related U.S. Application Data
(60) Provisional application No. 63/505,099, filed on May 31, 2023.

(51) Int. Cl. C08G 75/23; B01D 69/08; B01D 71/38; B01D 71/40; B01D 71/68; B01D 71/78; C08F 293/00; C08G 81/02

(52) U.S. Cl. CPC C08G 75/23; B01D 69/08; B01D 71/38; B01D 71/40; B01D 71/68; B01D 71/78; C08F 293/005; C08G 81/021; B01D 2311/2688; C08F 2438/01

(57) ABSTRACT

Functional diphenylsulfone macromers with grafted polymeric sidechains, copolymers having repeat units derived from the functional diphenylsulfone macromers with grafted polymeric sidechains, and porous polymeric articles containing these copolymers are provided. The grafted polymeric sidechains contain repeat units derived from a monomer having an ethylenically unsaturated group. The porous polymeric article, which is typically a membrane that can be either a flat sheet or a hollow fiber, can be used to separate mixtures of biomaterials having different average sizes based on the average pore size of the porous polymeric articles. For example, biomaterials such as proteins, viruses, and cells can be separated based on size.

### BACKGROUND

Separation devices having a porous polymeric substrate have been used in a wide range of different industrial, pharmaceutical, and medical applications. Some of these separation devices function by separating a mixture of materials based on the average size of the materials in the mixture. These separation devices typically retain materials of a certain size such as those having a diameter larger than the diameter of the pores in the polymeric substrate while allowing passage of other materials having a diameter smaller than the diameter of the pores in the polymeric substrate.

Membranes formed from polyether sulfone (PES) have been used for separating biological materials such as proteins, viruses, and cells based on size. The pore size of PES membranes can be tuned during membrane casting to suit a particular filtration need. Additionally, hydrophilic homopolymers such as, for example, poly(vinyl pyrrolidone) (PVP), poly(oxazoline) (POx), and poly(ethylene glycol) (PEG) can be added to the membrane casting solution to render the membrane hydrophilic and therefore somewhat resistant to fouling by biological components, oils, surfactants, and other fluid components that tend to adhere to membrane surfaces. However, membranes cast with these hydrophilic homopolymers frequently are not uniformly hydrophilic and remain susceptible to fouling when contaminated compositions are passed through them. Additionally, because these hydrophilic homopolymers are typically water soluble, a fraction of them can be extracted from the membrane during use. Therefore, users typically perform a pre-flush of the membrane to lower the extractable content to a suitable level before filtering the compositions of interest.

### SUMMARY

Functional diphenylsulfone macromers with grafted polymeric sidechains, copolymers having repeat units derived from the functional diphenylsulfone macromers with grafted polymeric sidechains, and porous polymeric articles containing these copolymers are provided. The grafted polymeric sidechains contain repeat units derived from a monomer having an ethylenically unsaturated group. The porous polymeric article, which is typically a membrane that can be either a flat sheet or a hollow fiber, can be used to separate mixtures of biomaterials having different average sizes based on the average pore size of the porous polymeric articles. For example, biomaterials such as proteins, viruses, and cells can be separated based on size. Further, the porous articles have chemical functionalities that can provide one or more desirable characteristics such as water wettability, resistance to fouling by proteins and other hydrophobic components of the fluids that are treated, ion exchange capabilities, absorption of certain fluid components, or the ability to adjust the effective pore size during use in response to changes in an environmental characteristic such as pH of the treated fluid.

In a first aspect, a compound of Formula (I) is provided.

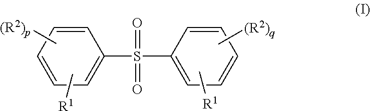

Each R¹ is independently a leaving group or a nucleophilic group. Each R² is independently a grafted polymeric sidechain comprising a plurality of repeat units derived from a monomer having an ethylenically unsaturated group. The compounds of Formula (I) can be referred to as macromers.

In a second aspect, a copolymer is provided. The copolymer comprises a plurality of repeat units joined by —O— groups. The plurality of repeat units includes (a) a first repeat unit of Formula (II)

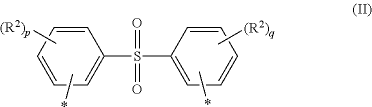

and (b) a second repeat unit of Formula (III).

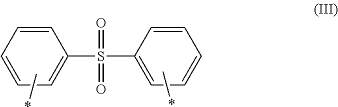

Each R² is independently a grafted polymeric sidechain comprising a plurality of repeat units derived from a monomer having an ethylenically unsaturated group. The variables p and q are each independently equal to 0, 1 or 2 with the sum of p+q being an integer equal to at least 1. Each asterisk (*) is an attachment site to an —O— group that joins repeat units.

In many embodiments of the second aspect, the first repeat unit of Formula (II) is of Formula (II-A) and/or Formula (II-B)

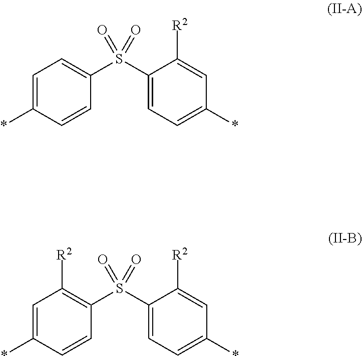

and the second repeat unit of Formula (III) is of Formula (III-A).

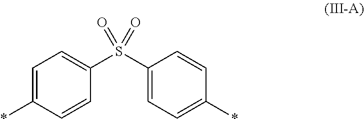

Each asterisk (*) is an attachment site to an —O— group that joins repeat units.

In a third aspect, a porous polymeric article is provided that comprises the copolymer described above in the second aspect. In most embodiments, the porous polymeric article is a membrane.

In a fourth aspect, a method of separating biomaterials is provided. The method includes providing a porous polymeric article as described above in the third aspect and passing an aqueous mixture of biomaterials through the porous polymeric article. The method further includes separating the mixture of biomaterials based on differences in average size, net charge, or permeability of the biomaterials.

As used herein, the terms “a”, “an”, “the”, and “at least one” are used interchangeably.

The term “and/or” means either or both. For example, “A and/or B” means A alone, B alone, or both A and B.

The term “alkyl” refers to a monovalent group that is a radical of an alkane. The alkyl group can have 1 to 32 carbon atoms, 1 to 20 carbon atoms, 1 to 12 carbon atoms, 1 to 10 carbon atoms, 1 to 6 carbon atoms, or 1 to 4 carbon atoms. The alkyl can be linear, branched, cyclic, or a combination thereof. A linear alkyl has at least one carbon atom while a cyclic or branched alkyl has at least 3 carbon atoms.

The term “(hetero)alkyl” refers to an alkyl, heteroalkyl, or both.

The term “heteroalkyl” refers to an alkyl having one or more of the catenated carbon atoms replaced by a heteroatom such as oxygen (—O—), sulfur (—S—), and nitrogen (e.g., —NR^{b}— where R^{b} is hydrogen or an alkyl). If there is more than one heteroatom, they are separated by at least one carbon atom.

The term “alkylene” refers to a divalent group that is a radical of an alkane. The alkylene group can have 1 to 32 carbon atoms, 1 to 20 carbon atoms, 1 to 12 carbon atoms, 1 to 10 carbon atoms, 1 to 6 carbon atoms, or 1 to 4 carbon atoms. The alkylene can be linear, branched, cyclic, or a combination thereof. A linear alkylene has at least one carbon atom while a cyclic or branched alkylene has at least 3 carbon atoms.

The term “(hetero)alkylene” refers to an alkylene or heteroalkylene.

The term “heteroalkylene” refers to an alkylene having one or more of the catenated carbon atoms replaced by a heteroatom such as oxygen (—O—), sulfur (—S—), and nitrogen (e.g., —NR^{b}— where R^{b} is hydrogen or an alkyl). If there is more than one heteroatom, they are separated by at least one carbon atom.

The term “alkaryl” refers to an aryl group substituted with at least one alkyl group. The alkaryl usually contains 7 to 20 carbon atoms. The alkaryl group often contains an alkyl group having 1 to 20 carbon atoms and an aryl group having 6 to 10 carbon atoms.

The term “(hetero)alkaryl” refers to an alkaryl or heteroalkaryl group.

The term “heteroalkaryl” refers to alkaryl group having one or more of the catenated carbon atoms replaced by a heteroatom such as oxygen, sulfur, or nitrogen. If there is more than one heteroatom, they are separated by at least one carbon atom. The heteroatom can be in either the aryl or alkyl group of the heteroalkaryl.

The term “aralkyl” refers to an alkyl group substituted with at least one aryl group. The aralkyl group usually contains 7 to 20 carbon atoms. The aralkyl group often contains an alkyl group having 1 to 10 carbon atoms and an aryl group having 6 to 10 carbon atoms.

The term “(hetero)aralkyl” refers to an aralkyl or a heteroaralkyl group.

The term “heteroaralkyl” refers to an aralkyl having one or more of the catenated carbon atoms replaced by a heteroatom such as oxygen, sulfur, or nitrogen. If there is more than one heteroatom, they are separated by at least one carbon atom. The heteroatom can be in either the aryl or alkyl group of the heteroaralkyl.

The term “aryl” refers to a monovalent group that is a radical of an aromatic carbocyclic compound. The aryl group has at least one aromatic carbocyclic ring and can have 1 to 3 optional rings that are connected to or fused to the aromatic carbocyclic ring. The additional rings can be aromatic, aliphatic, or a combination thereof. The aryl group usually has 5 to 20 carbon atoms or 6 to 10 carbon atoms.

The term “(hetero)aryl” refers to an aryl, heteroaryl, or both.

The term “heteroaryl” refers to a monovalent group that is a radical of an aromatic heterocyclic compound. The heteroaryl has at least one aromatic heterocyclic ring and can have optional rings that are connected or fused to the aromatic heterocyclic ring. The additional rings can be aromatic, aliphatic, or a combination thereof. The heteroaryl typically has 5 to 20, 5 to 12, or 5 to 10 ring atoms with at least one ring atom being a heteroatom such as oxygen, sulfur, or nitrogen.

The term “(meth)acryloyl” refers to a group of formula CH₂═CHR^{b}—(CO)— where R^{b} is hydrogen or methyl and the group-(CO)— refers to a carbonyl group.

The term “(meth)acrylate” refers to an acrylate, a methacrylate, or both. Likewise, the term “(meth)acrylamide” refers to an acrylamide, a methacrylamide, or both and the term “(meth)acrylic acid” refers to acrylic acid, methacrylic acid, or both.

The term “vinyl monomer” refers to a monomer having an ethylenically unsaturated group that is not a (meth)acryloyl group.

The term “leaving group” refers to a group that can depart from a compound with a pair of electrons such as, for example, —F, —Cl, —Br, —I, CF₃SO₃—, and —SO₃—C₆H₄—CH₃.

The term “nucleophilic group” refers to a group that has an electron-rich atom that can donate a pair of electrons to form a covalent bond. As used herein, the nucleophilic group is often hydroxy (—OH) or —O—Si(R^{c})₃ where R^{c} is an alkyl or aryl.

The term “macromer” is used to refer to a reactive compound having a polymeric group. More particularly, as used herein, the term macromer refers to a functional diphenylsulfone compound having (1) at least two functional groups that are leaving groups or nucleophilic groups and (2) a covalently attached (grafted) polymeric sidechain that is derived from ethylenically unsaturated monomers. The number of functional groups is usually equal to two.

The term “monomer” is used herein to refer to a reactive compound that does not have a polymeric group. The monomer is typically a compound having at least two functional groups that are leaving groups or nucleophilic groups. The number of functional groups is usually equal to two.

The terms “polymer” and “polymeric material” are used interchangeably and refer to materials formed by reacting one or more monomers. The terms include homopolymers, copolymers, terpolymers, or the like. Likewise, the terms “polymerize” and “polymerizing” refer to the process of making a polymeric material that can be a homopolymer, copolymer, terpolymer, or the like. The term “copolymer” is used herein to refer to a polymer and polymeric materials derived from more than one type of monomer and/or macromer.

The terms “casting solution” and “polymer dope” are used interchangeably to refer to the composition used to form a porous membrane.

The term “membrane” refers to a porous article that is formed from a polymeric composition. The membrane can be in the form of a flat sheet or a hollow fiber. The membranes described herein are typically prepared using a phase separation process.

For any stated range, the endpoints are considered part of the range.

### BRIEF DESCRIPTION OF THE DRAWINGS

FIG. 1 illustrates a perspective view of a partial cross-section of a portion of an exemplary hollow fiber membrane.

FIG. 2 illustrates a cross-section view of an exemplary hollow fiber membrane.

FIG. 3 is a plot of membrane permeability as a function of pH for three exemplary membranes.

FIG. 4 is a scanning electron micrograph of a cross section of an exemplary hollow fiber membrane of Example HFM1 at a magnification of 200 times.

FIG. 5 is a scanning electron micrograph of a cross section of an exemplary hollow fiber membrane of Example HFM1 at a magnification of 1,000 times.

FIG. 6 is a scanning electron micrograph of an inner lumen wall of an exemplary hollow fiber membrane of Example HFM1 at a magnification of 5,000 times.

FIG. 7 is a scanning electron micrograph of an outside wall of an exemplary hollow fiber membrane of Example HFMI1 at a magnification of 5,000 times.

FIG. 8 is a scanning electron micrograph of a cross section of an exemplary hollow fiber membrane of Comparative Example CHFM1 at a magnification of 200 times.

FIG. 9 is a scanning electron micrograph of a cross section of an exemplary hollow fiber membrane of Comparative Example CHFM1 at a magnification of 1,000 times.

FIG. 10 is a scanning electron micrograph of an inner lumen wall of an exemplary hollow fiber membrane of Comparative Example CHFM1 at a magnification of 5,000 times.

FIG. 11 is a scanning electron micrograph of an outside wall of an exemplary hollow fiber membrane of Comparative Example CHFMI1 at a magnification of 5,000 times.

FIG. 12 is a plot of flux of a 0.1 weight percent TWEEN-80 solution divided by flux of a buffer solution without TWEEN-80 as a function of volumetric throughput for membrane modules containing a hollow fiber membrane of Example HFM1 and Comparative Example CFM1.

### DETAILED DESCRIPTION

Functional diphenylsulfone macromers having grafted polymeric sidechains derived from an ethylenically unsaturated monomer, copolymers having repeat units derived from the functional diphenylsulfone macromers, and porous polymeric articles containing the copolymers are provided. The porous polymeric article, which is typically a membrane that can be either a flat sheet or a hollow fiber, can be used to separate mixtures of materials such as biomaterials having different average size, net charge, or permeability.

Advantageously, because the copolymers include macromeric units having covalently attached polymeric sidechains that are hydrophilic, the amount of pre-flushing that needs to be done to remove extractable hydrophilic polymers from a porous polymeric article prepared from these copolymers can be substantially reduced. Additionally, the grafted polymeric sidechains of the copolymer result in the formation of membranes with uniform hydrophilic surfaces. Consequently, these membranes tend to have greater resistance to fouling than those formed using hydrophilic homopolymers. The composition of the polymeric side chains can be selected to provide various useful surface chemistries to alter the surface charge, to provide chemical groups effective at binding certain fluid components in a filtered solution, or to provide grafted polymeric chains that can change conformation in response to an environmental characteristic such as pH. Additionally, the copolymers with grafted polymeric sidechains are typically amphiphilic but not water soluble. Because these copolymers are typically not water soluble, they are typically less extractable than the previously used hydrophilic homopolymers.

Functional Diphenylsulfone Macromers with Grafted Polymeric Sidechains

Functional diphenylsulfone macromers are provided with grafted polymeric sidechains. The grafted polymeric sidechains are formed from an ethylenically unsaturated monomer. These macromers with grafted polymeric sidechains typically have at least two functional groups that can react with other monomers having suitable functional groups to form a copolymer. The functional groups can be either leaving groups or nucleophilic groups.

The functional diphenylsulfone macromers are of Formula (I).

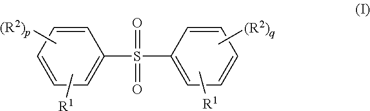

Each R¹ is a functional group that is independently a leaving group or a nucleophilic group. Each R² is independently a grafted polymeric sidechain comprising a plurality of repeat units derived from a monomer having an ethylenically unsaturated group. The variables p and q are each independently equal to 0, 1 or 2 with the sum of p+q being an integer equal to at least 1. Each asterisk (*) is an attachment site to an —O— group that joins repeat units.

Each group R¹ is independently a leaving group or a nucleophilic group. Suitable leaving groups include, for example, —F, —Cl, —Br, —I, —SO₃—CF₃—, and —SO₃—C₆H₄—CH₃. Suitable nucleophilic groups include, for example, —OH or —O—Si(R⁶)₃ where each R⁶ group is an alkyl such as those having 1 to 4 carbon atoms. If R¹ is a hydroxy group, it is typically protected during the formation of the R² grafted polymeric sidechains. For example, the hydroxy group can be protected as a —O—Si(R⁶)₃ group. If desired, the nucleophilic group —O—Si(R⁶)₃ can be converted to a —OH group after formation of the compound of Formula (I) having the grafted polymeric sidechains. It is the group R¹ that is reactive (i.e., functional) when a polymeric material (i.e., copolymer) is formed that includes repeat units derived from the macromer of Formula (I).

In the macromer of Formula (I), a first aromatic ring can have p groups of formula R² while a second aromatic ring can have q groups of formula R². The variable p and q are each an integer in a range of 0 to 2 with the sum of p+q being equal to at least 1. Thus, the number of R² groups in the macromer of Formula (I) is equal to 1, 2, 3, or 4. In many embodiments, there is a single R² group per macromer (p+q is equal to 1) or a single R² group on each aromatic ring (p+q is equal to 2).

Each R² is independently a grafted polymeric sidechain comprising a plurality of repeat units derived from a monomer having an ethylenically unsaturated group. Any suitable (meth)acrylate, (meth)acrylamide, or vinyl monomer can be used. The polymeric sidechain can be formed from a single monomer or from a mixture of different monomers. That is, the polymeric sidechain can be a homopolymer, random copolymer, or a block copolymer.

In many embodiments, the monomers that are used to form R² are of Formula (VII).

CH₂═CR³—X—R⁴ (VII)

In Formula (VII), R³ is hydrogen or methyl. Group X is —(C═O)—NR⁹—, —(C═O)—O—, or absent. When X is —(C═O)—NR⁹—, the monomer of Formula (VII) is a (meth)acrylamide. When X is —(C═O)—O—, the monomer of Formula (VII) is a (meth)acrylate. When X is absent, the monomer of Formula (VII) is a vinyl monomer. Group R⁹ is hydrogen, alkyl, or combines with R⁴ and nitrogen to form a heterocyclic ring. Group R⁴ is hydrogen, (hetero)alkyl, (hetero)aryl, (hetero)alkaryl, or (hetero)aralkyl. The (hetero)alkyl, (hetero)aryl, (hetero)alkaryl, and (hetero)aralkyl can be optionally substituted with an acidic group, hydroxyl group, or amino group of formula —N(R¹¹)₂ where each R¹¹ is independently hydrogen, a (hetero)alkyl, or both R¹¹ groups together with nitrogen form a heterocyclic ring.

Examples of alkyl (meth)acrylates include, but are not limited to, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, 2-methylbutyl (meth)acrylate, n-hexyl (meth)acrylate, cyclohexyl (meth)acrylate, 4-methyl-2-pentyl (meth)acrylate, 2-ethylhexyl (meth)acrylate, 2-methylhexyl (meth)acrylate, n-octyl (meth)acrylate, isooctyl (meth)acrylate, 2-octyl (meth)acrylate, isononyl (meth)acrylate, isoamyl (meth)acrylate, isobornyl (meth)acrylate, n-decyl (meth)acrylate, and isodecyl (meth)acrylate, 2-propylheptyl (meth)acrylate, lauryl (meth)acrylate, isotridecyl (meth)acrylate, n-octadecyl (meth)acrylate, isostearyl (meth)acrylate, and n-dodecyl (meth)acrylate.

Examples of heteroalkyl (meth)acrylates include, but are not limited to, 2-ethoxyethyl (meth)acrylate, 2-(2-ethoxyethoxy)ethyl (meth)acrylate, 2-methoxyethyl (meth)acrylate, tetrahydrofurfuryl (meth)acrylate, and various poly (alkylene oxide) (meth)acrylates such as polyethylene oxide (meth)acrylate, and polypropylene oxide (meth)acrylate. The poly (alkylene oxide) (meth)acrylates can have any suitable molecular weight but are often selected to have a number average molecular weight no greater than about 20,000 grams/mole such as up to 15,000, up to 10,000, up to 5,000, up to 2,000, up to 1,000, or up to 500 grams/mole.

Examples of aryl (meth)acrylates include, for example phenyl acrylate. Examples of an aralkyl (meth)acrylate include benzyl acrylate and 2-phenylethyl acrylate. Examples of heteroaralkyl (meth)acrylates include 2-phenoxyethyl acrylate.

Monomers with an acidic group include, but are not limited to, those selected from ethylenically unsaturated carboxylic acids, ethylenically unsaturated sulfonic acids, ethylenically unsaturated phosphonic acids, and mixtures thereof. Examples of such monomers include (meth)acrylic acid, itaconic acid, fumaric acid, crotonic acid, citraconic acid, maleic acid, oleic acid, β-carboxyethyl (meth)acrylate, 2-sulfoethyl methacrylate, styrene sulfonic acid, 2-acrylamido-2-methylpropanesulfonic acid, and vinyl phosphonic acid. Due to their availability, the acid monomers are often (meth)acrylic acids.

Example monomers having a hydroxyl group include, but are not limited to, hydroxyalkyl (meth)acrylates (e.g., 2-hydroxyethyl (meth)acrylate, 2-hydroxypropyl (meth)acrylate, 3-hydroxypropyl (meth)acrylate, and 4-hydroxybutyl (meth)acrylate), hydroxyalkyl (meth)acrylamides (e.g., 2-hydroxyethyl (meth)acrylamide and 3-hydroxypropyl (meth)acrylamide), ethoxylated hydroxyethyl (meth)acrylate (e.g., monomers commercially available from Sartomer (Exton, PA, USA) under the trade designation CD570, CD571, and CD572), and aryloxy substituted hydroxyalkyl (meth)acrylates (e.g., 2-hydroxy-2-phenoxypropyl (meth)acrylate). An example hydroxyl terminated polypropylene glycol acrylate is commercially available under the trade name BISOMER PPA 6 from Cognis, Germany.

Example monomers with a primary amido group include (meth)acrylamide. Exemplary monomers with secondary amido groups include, but are not limited to, N-alkyl (meth)acrylamides such as N-methyl (meth)acrylamide, N-ethyl (meth)acrylamide, N-isopropyl (meth)acrylamide, N-tert-octyl (meth)acrylamide, or N-octyl (meth)acrylamide. Exemplary monomers with a tertiary amido group include, but are not limited to, N-vinyl caprolactam, N-vinyl-2-pyrrolidone, (meth)acryloyl morpholine, and N,N-dialkyl (meth)acrylamides such as N,N-dimethyl (meth)acrylamide, N,N-diethyl (meth)acrylamide, N,N-dipropyl (meth)acrylamide, and N,N-dibutyl (meth)acrylamide.

Example monomers with an amino group include various N,N-dialkylaminoalkyl (meth)acrylates and N,N-dialkylaminoalkyl (meth)acrylamides. Examples include, but are not limited to, N,N-dimethyl aminoethyl (meth)acrylate, N,N-dimethylaminoethyl (meth)acrylamide, N,N-dimethylaminopropyl (meth)acrylate, N,N-dimethylaminopropyl (meth)acrylamide, N,N-diethylaminoethyl (meth)acrylate, N,N-diethylaminoethyl (meth)acrylamide, N,N-diethylaminopropyl (meth)acrylate, and N,N-diethylaminopropyl (meth)acrylamide.

Example vinyl monomers having a heteroatom include, but are not limited to, various vinyl ethers (e.g., vinyl methyl ether) and vinyl esters (e.g., vinyl acetate and vinyl propionate).

The sidechain R² can have any desired number of monomeric units. In many embodiments, the number of repeat units is in a range of 3 to 1000. This number can be at least 3, at least 5, at least 10, at least 15, at least 20, at least 25, at least 30, at least 35, at least 40, at least 45, at least 50, at least 100, at least 200, at least 300, at least 400, or at least 500 and up to 1000, up to 900, up to 800, up to 700, up to 600, up to 500, up to 400, up to 300, up to 200, up to 100, up to 90, up to 80, up to 70, up to 60, up to 50, up to 40, up to 30, or up to 20. For example, the sum can be in a range of 3 to 500, 3 to 100, 5 to 100, or 5 to 50.

In some embodiments, the macromer of Formula (I) is of Formulas (I-A) or (I-B).

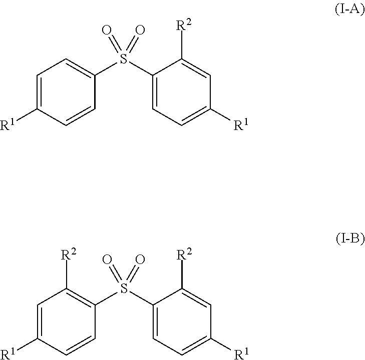

In these embodiments, p and q in Formula (I) is either 0 or 1 with the sum (p+q) being 1 or 2. The groups R¹ and R² are the same as described above for Formula (I). There can be a mixture of monomers of Formula (I-A) and (I-B)

Any suitable method can be used to form the macromers of Formula (I) such as those of Formula (I-A) and (I-B). In some embodiments, macromers of Formula (I-A) and/or (I-B) can be formed from an intermediate brominated compound using the method described in Reaction Scheme A.

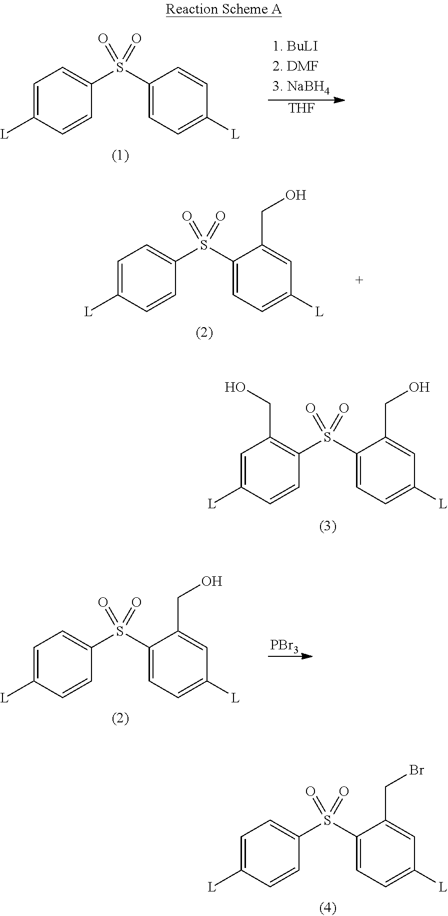

A pre-assembled diphenylsulfone with two leaving groups (L) (compound (1)) can be reacted sequentially in tetrahydrofuran with butyl lithium, dimethylformamide, and sodium borohydride to form a mixture of compounds (2) and (3). Compound (2) and/or compound (3) can then be reacted with phosphorous tribromide in the presence of a solvent such as dichloromethane. In practice, compounds (2) and (3) are often separated from each other using column chromatography prior to treatment with phosphorous bromide. For ease of description of the reaction scheme, the reaction with phosphorous bromide is shown only for compound (2). The brominated compound (4) can then be reacted to graft a polymeric sidechain to the diphenylsulfone compound.

An alternative route to compound (4) is shown in Reaction Scheme A-1. An electrophilic aromatic substitution using a sulfonyl chloride (compound (1a)) and a substituted toluene (compound (2a)) can provide a methyl substituted diphenyl sulfone (compound (3a)). This reaction is typically performed with a Lewis acid such as aluminum chloride (AlCl₃). Compound (3a) can then be reacted with a suitable brominating reagent, such as N-bromosuccinimide, to give the brominated compound (4).

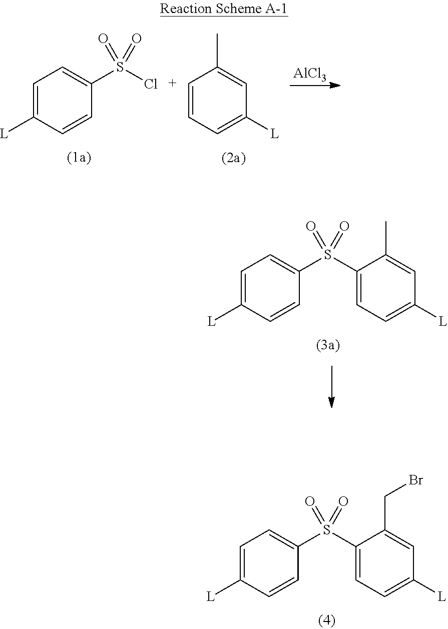

The polymeric sidechain can be formed from the intermediate brominated compound (e.g., compound (4)) using a variety of free radical polymerization reactions. In many embodiments, a controlled polymerization process such as an atomic transfer radical polymerization (ATRP) method or a reversible addition-fragmentation chain transfer (RAFT) method is used.

In a first method to prepare the polymeric sidechain, an ATRP controlled polymerization process is used. This method includes the use of a transition metal catalyst and a complexing ligand.

Any suitable transition metal catalyst and complexing agent known in the art can be used. As shown below in Reaction Scheme B, CuCl (cuprous chloride) can be used as the transition metal catalyst and 4,4′-dimethyl-2,2′-dipyridyl (DMDP) can be used as the complexing agent.

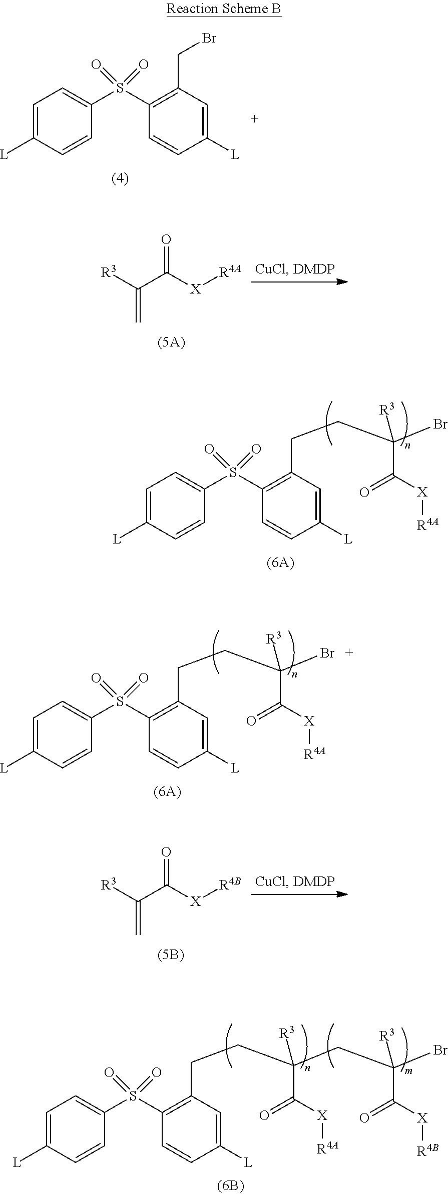

In Reaction Scheme B, compound (5A) is the same as the monomer of Formula (VII) described above. A single type of monomer or a plurality of different monomers of Formula (VII) can be used. Although compound (6A) shows polymeric sidechain —CH₂—{CH₂—CR³[(C═O)—X—R^{4A}]}ₙ—Br that is terminated with a bromide, the polymeric sidechain can be terminated with other groups depending on the composition of the reaction mixture including the selection of the ATRP agent. Likewise, although the monomeric repeat units in compound (6A) shows a —CH₂— linkage group between the aromatic ring and the monomeric repeat units, this linkage group can be any suitable group. Examples of the linkage groups include, but are not limited to, an alkylene, a heteroalkylene, an arylene, or a mixture thereof and can further include carbonyl groups, —O—,
—NH—, or any other suitable group and combinations thereof. The variable n is equal to the number of repeat units in the polymeric sidechain and is typically in a range of 3 to 1000 as discussed above.

If desired, compound (6A) can be further reacted with another monomeric material to form a polymeric sidechain that is a block copolymer. That is, compound (6A) optionally can be further reacted with a second monomer having a different R⁴ group than the first monomeric unit. For example, the structure of the block copolymer can be as shown in compound (6B) where the first block is formed from a first monomer of formula CH₂═CR³—C(═O)—R^{4A} and the second block is formed from second monomer of formula CH₂═CR³—C(═O)—R^{4B} where R^{4A} and R^{4B} are different R⁴ groups. The resulting polymeric sidechain would be of formula
—CH₂—{CH₂—CR³[(C═O)—X—R^{4A}]}ₙ—{CH₂—CR³[(C═O)—X—R^{4B}]}ₘ—Br where n and m respectively are the number of monomeric units derived from the first monomer and the second monomer. Yet further blocks can be added, if desired. Each block can be a homopolymer or a copolymer.

In a second method to form a polymeric sidechain, a RAFT agent is used. The RAFT agent often has a thiocarbonylthio-containing group, but other known RAFT agents can be used. In this reaction scheme, groups R³ and X are the same as described above for Reaction Scheme (B).

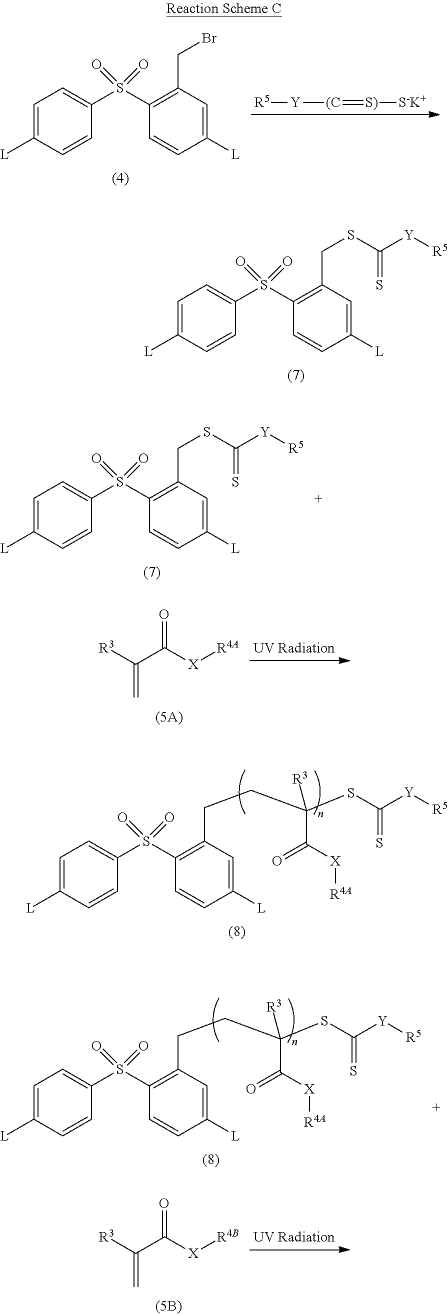

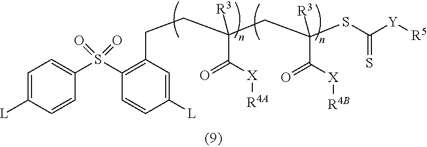

Initially, compound (4) is reacted a salt of formula R⁵—Y—(C═S)—S⁻K⁺ where group Y is —O—, NR⁵—, or —S— and where group R⁵ is often an alkyl, aryl, alkaryl, aralkyl. The salt can be a xanthate salt of formula R³—O—(C═S)—S⁻K⁺ where Y is equal to —O—, a dithiocarbamate salt of formula (R⁵)₂N—(C═S)—S⁻K⁺ when Y is equal to —NR⁵—, or a trithiocarbonate of formula R⁵—S—(C═S)—S⁻K⁺. The product of this reaction, which is compound (7), can be combined with a monomer of compound (5A), which is a first monomer of Formula (VII) described above. When the mixture of compound (7) and compound (5A) is exposed to UV radiation, compound (8) is formed. If desired, compound (8) can be further reacted with another monomeric material, having a different R⁴ group than the first monomeric unit, to form a polymeric sidechain that is a block copolymer. For example, the structure of the block copolymer can be as shown in compound (9) where the first block is formed from a first monomer of formula CH₂═CR³—C(═O)—R^{4A} and the second block is formed from second monomer of formula CH₂═CR³—C(═O)—R^{4B} where R^{4A} and R^{4B} are different R⁴ groups. The resulting polymeric sidechain would be of formula —CH₂—{CH₂—CR³[(C═O)—X—R^{4A}]}ₙ—{CH₂—CR³[(C═O)—X—R^{4B}]}ₘ—S—(C═S)—Y—R⁵ where n and m respectively are the number of monomeric units derived from the first monomer and the second monomer. Yet further blocks can be added, if desired. Each block can be a homopolymer or a copolymer.

Although compounds (8) shows polymeric sidechain —CH₂—{CH₂—CR³[(C═O)—X—R⁴]}ₙ—S—(C═S)—Y—R⁵ that is terminated with a group of formula —S—(C═S)—Y—R⁵, the polymeric sidechain can be terminated with other groups such as, for example, a thiol group (—SH). Likewise, the monomeric repeat units in compound (8) shows a —CH₂-linkage group between the aromatic ring and the monomeric repeat units, this linkage group can be any suitable group. Examples of the linkage groups include, but are not limited to, an alkylene, a heteroalkylene, an arylene, or a mixture thereof and can further include carbonyl groups, —O—, —NH—, or any other suitable group and combinations thereof. The variable n is equal to the number of repeat units in the polymeric sidechain and is typically in a range of 3 to 1000 as discussed above.

The functional diphenylsulfone macromers of Formula (I) typically have a weight average molecular weight (Mw) ranging from 380 to 50,000 Daltons. The Mw is often at least 380, at least 400, at least 500, at least 1000, at least 1500, at least 2000, at least 2500, at last 3000, at least 4000, at least 5000, at least 10,000, or at least 20,000 Daltons and up to 50,000, up to 45,000, up to 40,000, up to 30,000, up to 25,000, up to 20,000, up to 15,000, up to 10,000, or up to 5,000 Daltons. For example, the range can be from 380 to 20,000, 500 to 10,000, 1000 to 10,000, 2500 to 10,000, 2000 to 10,000, 2000 to 5000, or 2500 to 5000 Daltons. The weight average molecular weight of the compounds of Formula (I) can be determined by Nuclear Magnetic Resonance (NMR) spectroscopy as described in the Examples below.

Copolymers Having Repeat Units Derived from Functional Diphenylsulfone Macromers with Grafted Polymeric Sidechains

The difunctional diphenylsulfone macromers with grafted polymeric sidechains of Formula (I) can be used to form copolymers. For ease of discussion, this copolymer is herein referred to as “POLY-1”. POLY-1 is an amphiphilic graft copolymer.

POLY-1 is typically formed by reacting a first macromer of Formula (I) having grafted polymeric sidechains of formula R²

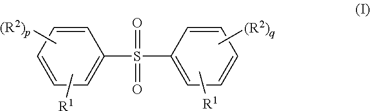

with a second monomer of Formula (IV)

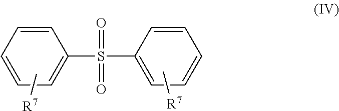

having two functional groups R⁷ that are either nucleophilic groups or leaving groups. Groups R¹ and R² plus the variables p and q are the same as defined above. The reaction product is typically a copolymer (POLY-1) with repeat units connected via a —O— group. In many embodiments, the first monomer of Formula (I) is of Formula (I-A) and/or (I-B).

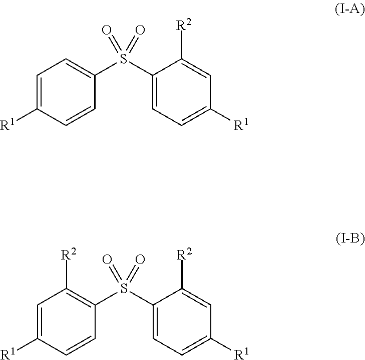

The repeat units of POLY-1 include first repeat units of Formula (II) derived from macromers of Formula (I)

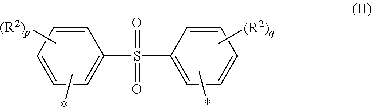

and second repeat units of Formula (III) derived from monomers of Formula (IV).

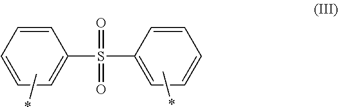

Copolymer POLY-1 contains a plurality of repeat units joined by —O— groups. Each asterisk (*) is an attachment site to an —O— group that joins repeat units. In many embodiments, POLY-1 has first repeat units of Formula (II-A) and/or (II-B).

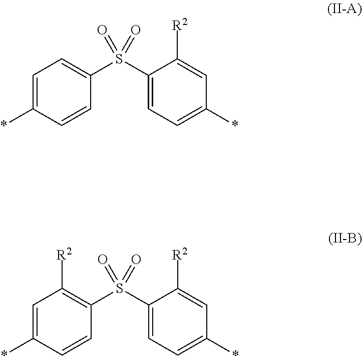

If R¹ in the first macromer of Formula (I) is a leaving group, then at least some of the second monomer of Formula (IV) has two hydroxy nucleophilic groups as shown in Formula (IV-A-1) or two group of formula —O—Si(R^{c})₃ where each R^{c} is an alkyl or aryl as shown in Formula (IV-A-2).

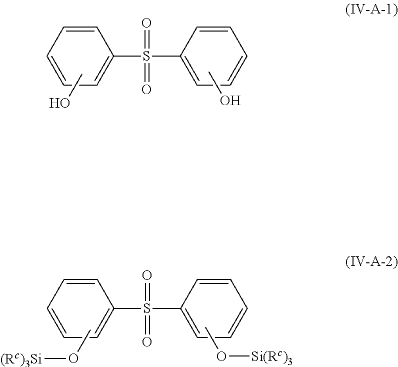

In most embodiments, the second monomer with nucleophilic groups is of Formula (IV-A-1).

If R¹ in the first macromer of Formula (I) is a nucleophilic group, however, then at least some of the second monomer of Formula (IV) has two leaving groups as shown in Formula (IV-B).

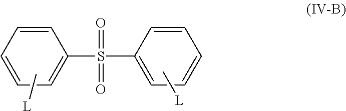

The two leaving groups are typically-F, —Cl, —Br, —I, CF₃SO₃—, and —SO₃—C₆H₄—CH₃

In many embodiments, the molar ratio of the first macromer of Formula (I) to the second monomer of Formula (IV) is less than 1. To provide a copolymer with molar ratios less than 1, a mixture of second monomers of Formula (IV) are used with some of the second monomers having R⁷ nucleophilic groups and other second monomers having R⁷ leaving groups. Thus, the second monomer is often a mixture of monomers of Formula (IV-A-1) and/or Formula (IV-A-2) plus monomers of Formula (IV-B). In many embodiments, the second monomer is a mixture of monomers of Formula (IV-A-1) and Formula (IV-B). The first and second monomers are combined such that the total moles of nucleophilic groups are equal to or approximately equal to the moles of leaving groups.

In many embodiments, the second monomer is of Formula (IV-C), Formula (IV-D), or a mixture thereof.

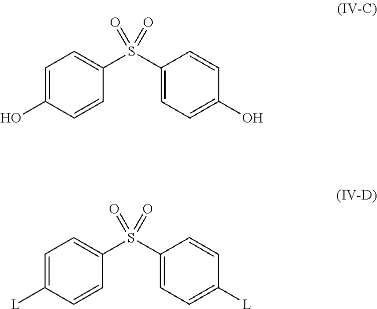

The monomer of Formula (IV-C) is within the scope of Formula (IV-A-1) above while the monomer of Formula (IV-D) is within the scope of Formula (IV-B) above. Group L is defined above but is often —Cl or —F.

The copolymer often has first repeat unit of Formula (II-A) and/or Formula (II-B)

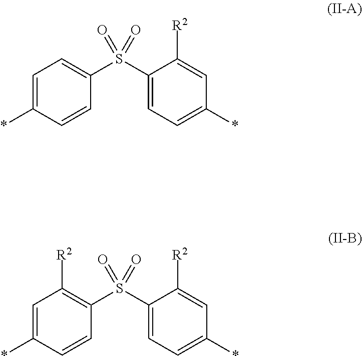

and second repeat unit of Formula (III-A).

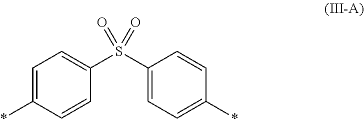

Each asterisk (*) is an attachment site to an —O— group that joins repeat units. Such a copolymer is formed from a macromer of Formula (I-A) and/or (I-B)

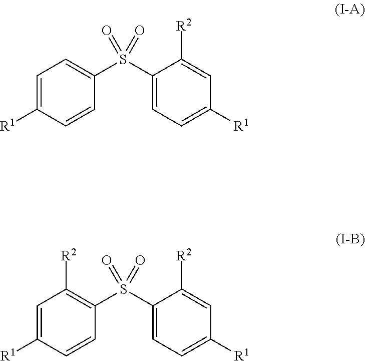

and a second monomer of Formula (IV-C) and/or (IV-D).

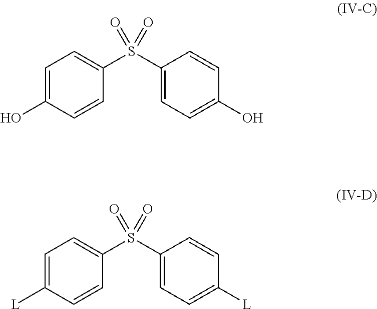

A mixture of (IV-C) and (IV-D) is often used. The groups R¹, R², and L are defined above.

POLY-1 can include additional optional repeat units in addition to those of Formulas (II) and (III). These optional repeat units include the following third repeat units of Formula (V-A), Formula (V-B), Formula (V-C), Formula (V-D), Formula (V-E), or a combination thereof.

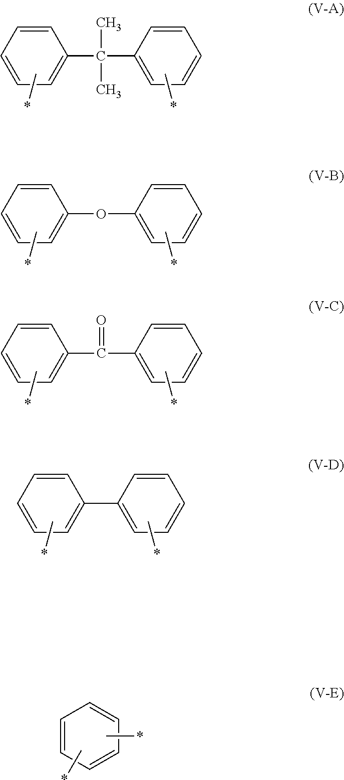

wherein an asterisk (*) is the attachment site to an —O— group that joins repeat units. In many embodiments these repeat units are derived from monomers such as, for example, those of Formula (VI-A) to (VI-E) respectively or isomers thereof. In these formulas, the group R⁸ is either a nucleophilic group or a leaving group as described above. In many embodiments, R⁸ is hydroxy.

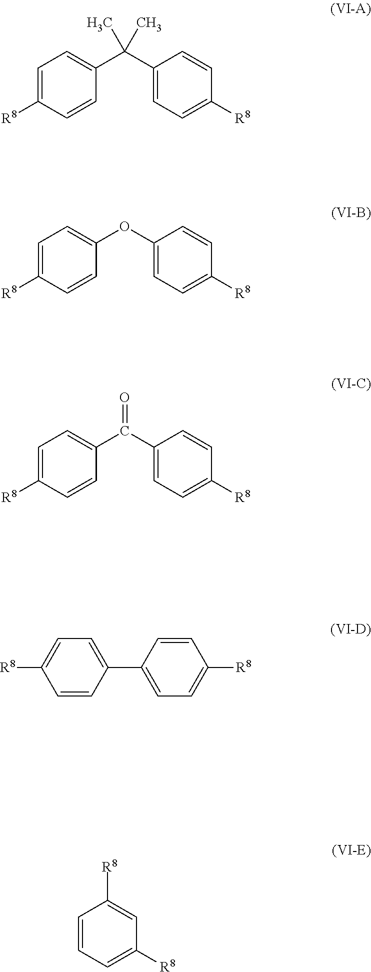

While any amount of the first macromer of Formula (I) can be used to form POLY-1, the amount typically needs to be controlled if the resulting copolymer POLY-1 is used to prepare a membrane such as those described below. For example, if the membrane is prepared using a phase separation process, the amount of first macromer of Formula (I) needs to be controlled so that POLY-1 is amphiphilic but not water soluble. If the amount of the first macromer of Formula (I) is too low, a membrane formed from this copolymer tends not to have sufficient antifouling characteristics and biomaterials such as proteins can undesirably stick to its surface, or, in the case of other desired surface characteristics such as environmentally responsive filtration performance, ion exchange capability, or affinity chromatography capability, the membrane tends not to have as much of the required functional moiety at the surface as desired. Increasing the amount of the first macromer of Formula (I) that is used to form the graft copolymer POLY-1 tends to increase the amount of POLY-1 on the membrane surface during solution induced phase separation (SIPS) casting and tends to provide the desired membrane surface properties (e.g., water wettability, fouling resistance, environmentally responsive filtration, or chromatographic performance) at lower concentrations of POLY-1 in the casting solution. If the content of the first macromer of Formula (I) is too great, however, POLY-1 may be water soluble. Water solubility of POLY-1 is generally undesirable because this can lead to loss of this copolymer into the precipitation bath during membrane casting and/or to higher water extractability of the graft copolymer from the finished membrane. Thus, it is often desirable to prepare POLY-1 with the maximum amount of the macromer of Formula (I) that can be incorporated while not rendering POLY-1 water-soluble. This maximum amount depends on the hydrophilicity of the grafted polymeric sidechains, which in turn depends on the composition of the grafted polymeric sidechains.

The amphiphilic grafted copolymer POLY-1 is often prepared from a monomer composition that contains 2 to 60 weight percent, or 10 to 60 weight percent, of a first macromer of Formula (I) based on a total weight of the monomers in the monomer composition. The amount of the first monomer is often at least 2, at least 10, at least 15, at least 20, at least 25, or at least 30 weight percent and up to 60, up to 55, up to 50, up to 45, up to 40, up to 35, or up to 30 weight percent based on the total weight of monomers in the monomer composition. In some embodiments, the amount of the first macromer of Formula (I) ranges from 2 to 55, 2 to 50, 2 to 45, 2 to 40, 2 to 30, 10 to 55, 10 to 50, 10 to 45, 10 to 40, 10 to 30, 15 to 60, 15 to 55, 15 to 50, 15 to 45, 15 to 40, 20 to 60, 20 to 55, 20 to 50, 20 to 45, 20 to 40, 20 to 35, or 20 to 30 weight percent based on the total weight of monomers in the monomer composition.

In addition to the macromer of Formula (I), the monomer composition used to form POLY-1 can contain 40 to 90 weight percent of a second monomer of Formula (IV). The amount of the monomer of Formula (IV) can be at least 40, at least 45, at least 50, at least 55, at least 60, at least 65, or at least 70 and up to 90, up to 85, up to 80, up to 75, up to 70, up to 65, or up to 60 weight percent based on a total weight of monomers in the monomer composition. In some embodiments, the amount of the second monomer of Formula (IV) ranges from 45 to 90, 50 to 90, 55 to 90, 60 to 90, 70 to 90, 40 to 85, 45 to 85, 50 to 85, 55 to 85, 60 to 85, 40 to 80, 45 to 80, 50 to 80, 55 to 80, 60 to 80, 65 to 80, or 70 to 80 weight percent based on the total weight of monomers in the monomer composition.

In addition to the macromer of Formula (I) and the monomer of Formula (IV), the monomer composition used to form POLY-1 can optionally contain 0 to 50 weight percent of a third monomer of Formula (V-A), (V-B), (V-C), (V-D), (V-E), or a mixture thereof. The amount of this third monomer, if present, can be at least 1, at least 2, at least at least 5, at least 10, or at least 15 and up to 50, up to 40, up to 30, up to 25, up to 20, up to 15, up to 10, or up to 5 weight percent based on the total weight of monomers in the monomer composition.

In some embodiments, the POLY-1 can be further reacted to change the monomeric units included in the grafted polymeric sidechain to other types of monomeric units. For example, a POLY-1 with grafted polymeric sidechains derived from tert-butyl (meth)acylate can be treated with an acid such as trifluoroacetic acid or para-toluene sulfonic acid (pTSA) to convert the —C(═O)—O—C(CH₃)₃ groups to —C(═O)—OH groups. This type of reaction can be performed post-preparation of POLY-1 because acidic groups such as carboxylic acid groups could prevent or interfere with the polymerization reaction to form POLY-1.

POLY-1 typically has a weight average molecular weight (Mw) ranging from 10,000 to 250,000 Daltons. The weight average molecular weight is typically at least 10,000, at least 15,000, at least 20,000 at least 25,000, at least 30,000, at least 35,000, at least 40,000, at least 45,000, at least 50,000, at least 75,000, or at least 100,000 Daltons and up to 250,000, up to 225,000, up to 200,000, up to 175,000, up to 150,000, up to 125,000, up to 100,000, up to 80,000, up to 60,000, up to 50,000, up to 40,000, up to 35,000, or up to 30,000 Daltons. In some embodiments, the range is from 20,000 to 200,000, 25,000 to 100,000, from 25,000 to 80,000, from 25,000 to 60,000, from 25,000 to 50,000, or from 25,000 to 40,000 Daltons. The weight average molecular weight can be determined by gel permeation chromatography (GPC) as described in the Examples below.

### Porous Polymeric Articles

Porous polymeric articles are provided that contain an amphiphilic grafted copolymer POLY-1 having repeat units derived from the functional diphenylsulfone macromers with grafted polymeric sidechains as described above. Although the porous polymeric article can be in any form, it typically is a membrane. The membrane can be, for example, in the form of a flat sheet or a hollow fiber. The membranes are typically formed by a phase separation process.

In many embodiments, the phase separation process used to form the membrane is a solvent induced phase separation (SIPS) process and the resulting membrane can be referred to as a “SIPS membrane”. SIPS membranes are sometime referred to by other names such as, for example, “DIPS membranes” formed by diffusion induced phase separation, “NIPS membranes” formed by non-solvent induced phase separation, or as “phase inversion membranes”. These processes are all referred to herein as SIPS processes and the products as SIPS membranes.

In a SIPS process, the polymeric material is combined with other solution components such as a suitable solvent for the polymeric material to prepare a substantially homogeneous solution that is referred to interchangeably as a “casting solution” or as a “polymer dope”. The casting solution is formed into either a flat sheet using a coating process or a hollow fiber using a spinning process. The flat sheet or hollow fiber is then immersed in a “quench solution” containing a non-solvent for the polymeric material. Exchange of the solvent in the casting solution with the non-solvent in the quench solution results in phase separation of the polymer solution yielding a solid, porous flat sheet or hollow fiber. In some embodiments, the flat sheet or hollow fiber can be exposed to a humid atmosphere or steam prior to immersion into the quench solution to begin the phase separation process.

The casting solution used to form the SIPS membrane typically includes a mixture of polymeric materials and a water-miscible organic solvent. The mixture of polymeric materials includes POLY-1 as described above having grafted polymeric sidechains, a second polymer POLY-2 that is typically an aromatic polyether sulfone lacking grafted polymeric sidechains, and an optional third polymer POLY-3 that is typically a hydrophilic pore former. In addition to the polymeric materials, the casting solution also contains a water-miscible solvent that can dissolve POLY-1, POLY-2, and optional POLY-3. Still further, the casting solution can optionally contain water.

The casting solution contains POLY-1, which is the copolymer described above that comprises (1) repeat units of Formula (II)

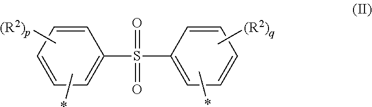

that is a diphenylsulfone with at least one grafted polymeric sidechain R² as well as (2) repeat units of Formula (III)

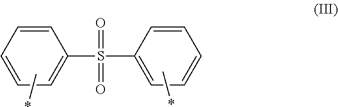

that is a diphenylsulfone without grafted polymeric sidechains. The casting solution typically contains 1 to 20 weight percent of POLY-1 based on a total weight of the casting solution. The amount can be at least 1, at least 1.5, at least 2, at least 2.5, at least 3, at least 4, or at least 5 weight percent and up to 20, up to 18, up to 15, up to 12, up to 10, up to 8, or up to 5 weight percent based on the total weight of the casting solution. For example, the amount of POLY-1 can be in a range of 1.5 to 20, 1.5 to 15, 2 to 20, 2 to 15, 2 to 10, or 2 to 5 weight percent based on the total weight of the casting solution. The various repeat units are connected by —O— linkages.

In addition to POLY-1, the casting solution includes a second polymer that is POLY-2. POLY-2 is an aromatic polyether sulfone having repeat units of Formula (III)

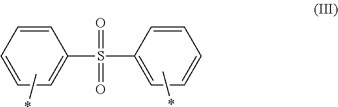

wherein an asterisk (*) is the attachment site to an —O— group that joins two repeat units. This second polymer can be a homopolymer or copolymer. If POLY-2 is a copolymer, it is free of repeat units of Formula (II) and is made from a monomer mixture that is free of the macromer of Formula (I). POLY-2 lacks the grafted polymeric sidechains that are included in POLY-1.

In some embodiments of POLY-2, the repeat units of Formula (III) are combined with one or more optional repeat units of Formula (V-A), Formula (V-B), Formula (V-C), Formula (V-D), Formula (V-E), or a combination thereof as described above as optional repeat units that can be included in POLY-1. These optional repeat units typically are no greater than 50 mole percent of all the repeat units in POLY-2. That is, they can be present in an amount of 0 to 50 mole percent based on all the repeat units included in POLY-2. For example, these optional repeat units can be up to 50, up to 45, up to 40, up to 35, up to 30, up to 25, up to 20, up to 15, up to 10, or up to 5 mole percent of all the repeat units in POLY-2.

POLY-2 typically has a weight average molecular weight (Mw) in a range of 30,000 to 150,000 Daltons (30 to 150 kDa). For example, Mw is often at least 30, at least 40, at least 50, at least 60, or at least 70 and up to 150, up to 140, up to 130, up to 120, up to 100, up to 90, up to 80, up to 70, up to 60, or up to 50 kDa. The range can be, for example, from 30 to 120, 50 to 120, or 60 to 100 kDa. The weight average molecular weight can be determined by gel permeation chromatography (GPC) as described in the Examples below.

The amount of POLY-2 in the casting solution is typically in a range of 10 to 40 weight percent based on the total weight of the casting solution. The amount can be at least 10, at least 12, at least 15, or at least 20 weight percent and up to 40, up to 35, up to 30, up to 25, up to 20, or up to 15 weight percent based on the total weight of the casting solution. For example, the amount of POLY-2 can be in a range of 10 to 35, 10 to 30, 10 to 25, 12 to 40, 12 to 35, 12 to 30, 12 to 25, 15 to 40, 15 to 35, 15 to 30, 15 to 25, 20 to 40, 20 to 35, or 20 to 30 weight percent based on the total weight of the casting solution. The amount of POLY-2 in the casting solution can impact the pore size of the resulting membrane formed from the casting solution. For example, an increase in the amount of POLY-2 tends to decrease the average pore size of the membrane. Varying the amount of POLY-2 can be used to alter the size of materials that can permeate though the membrane and/or the speed of permeation through the membrane.

An optional third polymeric material, which is referred to as POLY-3, is often included in the casting solution in addition to POLY-1 and POLY-2. This third polymer is typically selected to be a hydrophilic polymer that has greater water solubility than either POLY-1 or POLY-2. When phase separation occurs in the process of making the membrane, the third polymer (POLY-3) typically does not undergo phase separation. That is, POLY-3 remains in solution unlike both POLY-1 and POLY-2. Suitable POLY-3 hydrophilic polymers include, for example, polyvinylpyrrolidone, polyethylene glycol, polyoxazoline, polyvinyl alcohol, polyglycol monoester, carboxylmethylcellulose, a polysorbitate such as polyoxyethylene sorbitan monooleate, carboxymethylcellulose polyacrylic acid, polyacrylamide, a copolymer thereof, or a blend thereof. In many embodiments, POLY-3 is a polyethylene glycol or a polymeric mixture that includes polyethylene glycol.

POLY-3 can have any desired molecular weight but the amount of this polymer that remains in the membrane after preparation may be higher than desired if the molecular weight is too large. In some embodiments, the weight average molecular weight of POLY-3 is less than 1000 Daltons. For example, the weight average molecular weight may be up to 750 Daltons such as in a range of 100 to 750, 100 to 500, 100 to 400, 200 to 750, 200 to 500, or 200 to 400 Daltons. In other embodiments, however, the molecular weight of one or more components of POLY-3 in the membrane is selected to be higher to impart greater fouling resistance or to tune the porosity of the membrane. In such cases the weight average molecular weight of that component of POLY-3 is often greater than 1000 Daltons. For example, the weight average molecular weight of that component of POLY-3 can be up to 750,000 Daltons such as in a range of 1,100 to 750,000 Daltons, 1,100 to 500,000 Daltons, 1,100 to 400,000 Daltons, 2,000 to 500,000 Daltons, or 20,000 to 50,000 Daltons. The weight average molecular weight can be determined by gel permeation chromatography (GPC) as described in the Examples below.

The amount of POLY-3 in the casting solution is typically in a range of 0 to 65 weight percent based on a total weight of the casting solution. The amount can be at least 5, at least 10, at least 15, at least 20, at least 25, at least 30, at least 35, or at least 40 weight percent and up to 65, up to 60, up to 55, up to 50, up to 45, up to 40, or up to 35 weight percent based on the total weight of the casting solution. For example, the amount can be in a range of 1 to 65, 1 to 60, 5 to 60, 10 to 60, 10 to 50, 10 to 40, 10 to 30, 20 to 60, 20 to 50, 20 to 40, 30 to 30 to 60, 30 to 50, or 30 to 40 weight percent based on the total weight of the casting solution.

In addition to POLY-1, POLY-2, and POLY-3, the casting solution can include a water-miscible organic solvent. Water-miscible organic solvents that can be used include, for example, glycol, glycerol, butyrolactone, ε-caprolactam, N-methyl pyrrolidone, dimethyl sulfoxide, dimethyl acetamide, dimethyl formamide, and combinations thereof. In some embodiments, the water-miscible organic solvent includes N-methyl pyrrolidone because it usually is a good solvent for both POLY-1 and POLY-2.

Any suitable amount of the water-miscible organic solvent can be included in the casting solution. The amount can be, for example, in a range of 20 to 70 weight percent based on a total weight of the casting solution. The amount can be at least 20, at least 25, at least 30, at least 35, at least 40, or at least 45 weight percent and up to 70, up to 65, up to 60, up to 55, up to 50, up to 45, or up to 40 weight percent based on the total weight of the casting solution. For example, the amount can be in a range of 20 to 65, 20 to 60, 20 to 55, 20 to 50, 20 to 45, 20 to 40, 25 to 65, 25 to 60, 25 to 55, 25 to 50, 25 to 45, 25 to 40, 30 to 60, 30 to 55, 30 to 50, 30 to 45, or 30 to 40 weight percent based on the total weight of the casting solution.

The casting solution can optionally include water. For example, the casting solution can contain 0 to 10 weight percent water. If present, the amount can be at least 1, at least 2, at least 3, at least 4, or at least 5 and up to 10, up to 8, up to 6, up to 5, or up to 4 weight percent based on the total weight of the casting solution. The amount can be, for example, in a range of 1 to 8, 1 to 6, 1 to 5, 2 to 10, 2 to 8, 2 to 6, 2 to 5, 3 to 10, 3 to 8, 3 to 6, or 3 to 5 weight percent based on the total weight of the casting solution.

In some embodiments, the casting solution contains 1 to 20 weight percent POLY-1, 10 to 40 weight percent POLY-2, 0 to 65 weight percent POLY-3, 20 to 70 weight percent water-miscible organic solvent, and 0 to 10 weight percent water based on a total weight of the casting solution. In some examples, the casting solution contains 1.5 to 15 weight percent POLY-1, 12 to 30 weight percent POLY-2, 20 to 50 weight percent POLY-3, 25 to 55 weight percent water-miscible organic solvent, and 2 to 6 weight percent water. In other examples, the casting solution contains 2 to 10 weight percent POLY-1, 15 to 25 weight percent POLY-2, 30 to 40 weight percent POLY-3, 30 to 40 weight percent water-miscible organic solvent, and 3 to 5 weight percent water. In most embodiments, the casting solution is transparent and macroscopically homogeneous.

The membrane that is formed from the casting solution can be either in the form of a sheet or a hollow fiber membrane. Both types of membranes can be formed from the casting solution. After casting either a sheet or hollow fiber, the sheet or the hollow fiber is immersed in a quenching bath that results in the precipitation of the membrane. If desired, the membrane can optionally be transferred to a second bath such as a water bath to extract additional materials from the membrane.

In many embodiments, the precipitation bath includes water and optionally can further include water-miscible organic solvents such as those listed above for use in the casting solution. For example, the precipitation bath often contains 50 to 100 weight percent water and 0 to 50 weight percent of a water-miscible organic solvent. In some embodiments, the precipitation bath includes 55 to 100 weight percent water and 0 to 45 weight percent water-miscible organic solvent or 60 to 100 weight percent water and 0 to 40 weight percent water-miscible organic solvent. The water-miscible solvent is often selected to be N-methyl pyrrolidone.

While any suitable method can be used to form a membrane sheet, the casting solution is often heated to an elevated temperature such as, for example, in a range of 40 to 80 degrees Celsius. The casting solution can be coated onto a support that is also heated in a range of 40 to 80 degrees Celsius. The film can be prepared as a coating using, for example, a notch bar with a suitable gap height, such as in a range of 25.4 to 508 micrometers. The notch bar is often heated in a range of 40 to 80 degrees Celsius before spreading the casting solution out on the surface of the support. Immediately after forming a film of the casting solution on the support, the coated support is typically immersed into the precipitation bath that is often heated in a range of 40 to 80 degrees Celsius. If desired, the membrane optionally can be further extracted in a second bath that contains water. The membrane can be dried in an oven after formation. The temperature of the oven can be, for example, in a range of 40 to 80 degrees Celsius.

In some embodiments, the membrane is in the form of a sheet. The sheet typically has a thickness in a range of 30 to 250 micrometers. For example, the thickness can be at least 30, at least 40, at least 50, at least 60, at least 80, or at least 100 and up to 250, up to 225, up to 200, up to 175, up to 150, up to 125, up to 120, up to 110, or up to 100 micrometers. The range can be, for example, from 30 to 200, 30 to 150, 50 to 150, 50 to 125, 50 to 110, or 50 to 100 micrometers.

In many embodiments, the membrane is in the form of a hollow fiber. The hollow fiber can be formed by extruding the casting solution though a coaxial spinneret die. This coaxial spinneret die typically has an annular gap as well as a central inner channel that is arranged coaxially to the annular gap. The annular gap is separated from the central inner channel by a needle. The casting solution is introduced into the annular gap while a bore liquid is introduced into the inner chamber. The bore liquid stabilizes the lumen of the hollow fiber membrane as it is formed.

The spinneret die is selected depending on the desired dimensions of the hollow fiber membranes. While any suitable spinneret die can be used, the outer diameter of the annulus is often in a range of 300 to 1000 micrometers. The annulus outer diameter can be, for example, at least 300, at least 400, at least 500 and up to 1000, up to 800, or up to 600 micrometers. The inner diameter of the annulus, which is also the outer diameter of the needle, is often in a range of 190 to 980 micrometers. The annulus inner diameter can be, for example, at least 190, at least 200, at least 300, or at least 500 and up to 980, up to 900, up to 800, up to 600, or up to 500 micrometers. The inner diameter of the needle is often in a range of 40 to 830 micrometers. The needle inner diameter can be, for example, at least 40, at least 50, at least 75, at least 100, at least 150, at least 200 at least 250, at least 300, at least 350, at least 400 and up to 830, up to 800, up to 750, up to 700, up to 650, up to 600, up to 550, or up to 500 micrometers.

One exemplary spinneret die has an annulus outer diameter of 1000 micrometers, a needle outer diameter of 980 micrometers, an annular gap of 10 micrometers, a needle inner diameter of 830 micrometers, and a needle thickness of 75 micrometers. Another exemplary spinneret die has an annulus outer diameter of 500 micrometers, a needle outer diameter of 300 micrometers, an annular gap of 100 micrometers, a needle inner diameter of 150 micrometers, and a needle thickness of 75 micrometers. Yet another exemplary spinneret die has an annulus outer diameter of 410 micrometers, a needle outer diameter of 300 micrometers, an annular gap of 55 micrometers, a needle inner diameter of 150 micrometers, and a needle thickness of 75 micrometers. Still another exemplary spinneret die has an annulus outer diameter of 300 micrometers, a needle outer diameter of 190 micrometers, an annular gap of 55 micrometers, a needle inner diameter of 40 micrometers, and a needle thickness of 75 micrometers.

The bore liquid composition typically includes a water-miscible organic solvent, water, and optionally a hydrophilic polymer such as those listed above for POLY-3. Any suitable water-miscible organic solvent can be used such as those described above for use in the casting solution. In some embodiments, the water-miscible organic solvent used in the bore liquid includes N-methyl pyrrolidone and any optional hydrophilic polymer used in the bore liquid includes polyethylene glycol.

The amount of the water-miscible organic solvent in the bore liquid composition is often in a range of 30 to 95 weight percent based on a total weight of the bore liquid. The amount can be at least 30, at least 35, at least 40, at least 45, or at least 50 weight percent and up to 95, up to 90, up to 85, up to 80, up to 75, up to 70, up to 65, up to 60, up to 55, or up to 50 weight percent. For example, the amount can be in a range of 30 to 90, 30 to 80, 30 to 75, 30 to 70, 30 to 60, 30 to 50, 40 to 90, 40 to 80, 40 to 75, 40 to 70, 40 to 60, or 40 to 50 weight percent.

The amount of water in the bore liquid composition is often in a range of 1 to 55 weight percent based on a total weight of the bore liquid. The amount can be at least 1.5, at least 2, at least 2.5, at least 3, at least 4, at least 5, at least 10 weight percent and up to 55, up to 50, up to 45, up to 40, up to 35, up to 30, up to 25, up to 20, up to 15, or up to 10 weight percent. For example, the amount can be in a range of 1 to 50, 1 to 40, 1 to 30, 1 to 20, 1 to 15, 1 to 10, 2 to 50, 2 to 40, 2 to 30, 2 to 20, 2 to 15, 2 to 10, 5 to 50, 5 to 40, 5 to 30, 5 to 20, or 5 to 15 weight percent.

The amount of the optional hydrophilic polymer in the bore liquid composition is often in a range of 0 to 60 weight percent based on the total weight of the bore liquid. The amount can be 0, at least 1, at least 5, at least 10, at least 15, at least 20, at least 25, at least 30, at least 35, at least 40 weight percent and up to 60, up to 55, up to 50, up to 45, up to 40, up to 35, or up to 30 weight percent. For example, the amount can be in a range of 0 to 50, 10 to 60, 10 to 55, 10 to 50, 10 to 45, 10 to 40, 20 to 60, 20 to 55, 20 to 50, 20 to 45, 20 to 40, 30 to 60, 30 to 55, 30 to 50, 30 to 45, 40 to 60, or 40 to 50 weight percent.

Overall, the bore liquid composition contains 30 to 95 weight percent water-miscible organic solvent, 1 to 55 weight percent water, and 0 to 60 weight percent of the optional hydrophilic polymer. In some examples, the bore liquid composition contains 35 to 80 weight percent water-miscible organic solvent, 2 to 40 weight percent water, and 20 to 55 weight percent hydrophilic polymer. In other examples, the bore liquid composition contains 35 to 75 weight percent water-miscible organic solvent, 2 to 20 weight percent water, and 30 to 55 weight percent hydrophilic polymer. In still other examples, the bore liquid composition contains 40 to 50 weight percent water-miscible organic solvent, 5 to 15 weight percent water, and 40 to 50 weight percent hydrophilic polymer. Typically, the bore liquid is transparent and macroscopically homogenous.

As noted above, the bore liquid is introduced into the inner chamber while the casting solution is introduced into the annular gap of the coaxial spinneret die. In some embodiments, the casting solution is passed through a filter to remove any particulate materials prior to introduction into the annular gap. Both fluid streams are often heated prior to introduction into the die. For example, both fluid streams can be heated in a range of 30 to 80 degrees Celsius. The flow rate of the bore liquid and the flow rate of the casting solution each usually can be independently controlled.

After leaving the coaxial spinneret die and before entering the precipitation bath, the extruded product optionally passes through a climate-controlled zone with defined climatic conditions. The climate-controlled zone is often in the form of an encapsulated chamber. The extruded product often has a retention time no greater than 10 seconds within the climate-controlled zone having a relative humidity of 20 to 95 percent and a temperature of 25 to 75 °C. The relative humidity is often at least 40, at least 50, at least 55, at least 60, at least 65, at least 70, or at least 75 percent and up to 90, up to 85, up to 80, up to 75, or up to 70 percent. The temperature is often at least 25, at least 30, at least 35, at least 40, at least 45, or at least 50 degrees Celsius and up to 90, up to 85, up to 80, or up to 75 degrees Celsius. For example, the climate-controlled zone contains air with a relative humidity of 75 to 90% and a temperature of 30 to 50 °C, a relative humidity of 60 to 75% and a temperature of 50 to 70 °C, or a relative humidity of 75 to 90% and a temperature of 50 to 70 °C.

The retention time within the climate-controlled zone is often at least 0.5, at least 1, at least 2, or at least 3 and up to 10, up to 8, up to 6, or up to 5 seconds. To establish stable conditions in the climate-controlled zone, the air often flows through the climate-controlled zone with a velocity of less than 0.5 m/s and preferably with a velocity in the range from 0.15 to 0.35 m/s.

As the extruded product is directed through the climate-controlled zone set to the climatic conditions, pre-coagulation may occur on the outside of the extruded product by absorption of water vapor acting as the non-solvent, before entering the precipitation bath. Pre-coagulation or coagulation may also occur in a region near the inside of the extruded casting solution due to its exposure to the bore liquid.

After passing through the climate-controlled zone, the extruded product is directed into the precipitation bath that is in a range of 50 to 80 degrees Celsius to complete the formation of the hollow fiber membrane structure. The composition of the precipitation bath can be the same as described above to prepare membranes in the form of sheets. In the precipitation bath, the membrane structure is formed by precipitation (e.g., coagulation) and then stabilized. Extraction of the water-miscible solvents and the hydrophilic polymer occurs at the same time. That is, water, the water-miscible organic solvent, and at least a portion of the optional hydrophilic POLY-3 can be extracted. The pores of the membrane are formed within the precipitation bath due to the phase separation and extraction processes that occur.

After formation and extraction within the precipitation bath, the hollow fiber membrane can be processed using conventional methods. For example, the hollow fiber membrane optionally can be further treated by pouring deionized water through the lumen and extracted in water at an elevated temperature such as, for example, 70 to 100 degrees Celsius for several hours.

After drying either at room temperature or elevated temperatures, the hollow fiber membrane can be wound onto a coil or formed directly into bundles with a suitable fiber count and length. Before production of the bundles, supplementary threads in the form of multifilament yarns can be added to the hollow fiber membranes to ensure a spacing of the hollow fiber membranes relative to one another for better flow around the individual hollow fiber membranes in the bundle.

The membrane typically contains 1 to 50 weight percent POLY-1 based on a total weight of the membrane. For example, the membrane can contain at least 1, at least 2, at least 3, at least 5, at least 10, at least 15, at least 20, or at least 25 and up to 50, up to 45, up to 40, up to 35, up to 30, up to 25, or up to 20 weight percent POLY-1. The amount can be in a range of 2 to 50, 2 to 40, 3 to 30, 5 to 30, 5 to 25 or 5 to 20 weight percent based on a total weight of the membrane.

In addition to POLY-1, the membrane typically contains 50 to 99 weight percent POLY-2 based on a total weight of the membrane. The amount of POLY-2 can be at least 50, at least 55, at least 60, at least 65, at least 70, at least 75, or at least 80 and up to 99, up to 98, up to 97, up to 95, up to 90, up to 85, up to 80, up to 75 based on a total weight of the membrane. The amount of POLY-2 can be in a range of 50 to 98, 60 to 98, 70 to 97, 70 to 95, 75 to 95, or 80 to 95 based on a total weight of the membrane.

The membrane may optionally contain POLY-3, the water-miscible organic solvent, and/or water. The amount of POLY-3 is typically in a range of 0 to 20 weight percent based on the total weight of the membrane. For example, the amount of POLY-3 can be at least 0.1, at least 0.5, or at least 1, at least 2, at least 3, or at least 5 and up to 20, up to 15, up to 10, up to 8, or up to 5 weight percent. The amount of water-miscible organic solvent is typically in a range of 0 to 1 weight percent based on the total weight of the membrane. For example, the amount of the water-miscible organic solvent can be at least 0.05, at least 0.1, at least 0.2, at least 0.3, or at least 0.5 and up to 1, up to 0.8, up to 0.6, up to 0.5, up to 0.3, or up to 0.1 weight percent.

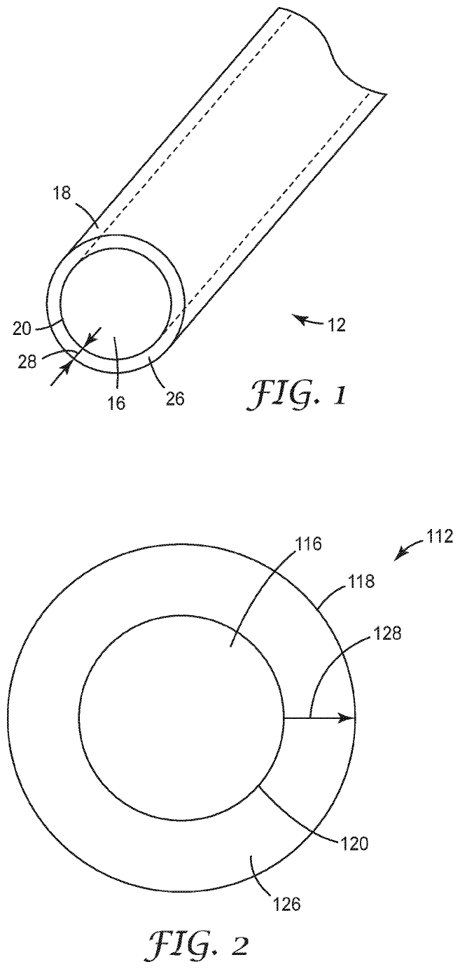

FIG. 1 illustrates a perspective view of a partial cross-section of a portion of an exemplary hollow fiber membrane 12. Hollow fiber membrane 12 may have a continuous hollow lumen 16 that extends from one end to the other end of the fiber. An outer surface 18 facing outwards forms an outer side of the fiber and an inner surface 20 facing towards the hollow lumen 16 defines a fiber portion 26 having a wall thickness 28. The fiber portion 26 is typically porous and contains a polymeric blend comprising a mixture of POLY-1 and POLY-2.

The hollow fiber membranes formed are typically an integrally asymmetric, permeable hollow fiber membrane. As used herein, the term “asymmetric” means that the average pore size varies throughout the wall thickness 28. The term “integrally” means that the pore size changes gradually in size over the wall thickness 28 of the fiber portion 26.

The wall thickness 28 of the fiber portion 26, measured between the outer surface 18 and the inner surface 20 of the fiber 26 portion of the hollow fiber membrane 12, can be in the range of from 10 to 400 micrometers or 20 to 300 micrometers. The fiber portion 26 is formed from the casting solution. The wall thickness can be at least 10, at least 20, at least 30, at least 40, at least 50, at least 60, at least 80, or at least 100 micrometers and up to 400, up to 350, up to 300, up to 275, up to 250, up to 225, up to 200, up to 175, up to 150, up to 125, up to 100, up to 80, or up to 60, or up to 50 micrometers. In some hollow fiber membranes, the wall thickness is in a range of 30 to 200, 30 to 100, 40 to 150, 40 to 100, 40 to 80, or 40 to 60 micrometers.

Similarly, to achieve a desirable flow and/or pressure drop through the lumen of the hollow fiber membranes, the inside diameter of the hollow fiber membranes, which corresponds to the diameter of the inner wall 20 in FIG. 1, is often in the range of from 50 to 800 micrometers. This diameter can be at least 50, at least 60, at least 80, at least 100, at least 150, at least 200, at least 250, or at least 300 micrometers and up to 800, up to 700, up to 600, up to 500, up to 400, up to 300, or up to 200 micrometers. In some hollow fiber membranes, the inside diameter is in a range of 50 to 700, 50 to 600, 100 to 500, 100 to 400, 100 to 300, or 100 to 200 micrometers.

Wall thicknesses and diameters (i.e., inner or lumen diameter, and outer diameter) of the membranes can be determined using scanning or transmission electron micrographs (SEM or TEM, respectively), for example with a magnification up to 20,000 times. In some embodiments, the hollow fiber membrane can have tortuous structures extending from the inner surface toward to the outer surface.

FIG. 2 illustrates a cross-section view of an exemplary hollow fiber membrane 112. Hollow fiber membrane 112 may have a continuous hollow lumen 116, which extends from one end to the other end of the fiber, an outer surface 118 facing outwards, which forms an outer side of the fiber; an inner surface 120 facing towards the hollow lumen 116, which defines the limits of the continuous hollow lumen 116. The fiber portion 126 of the membrane has a cross sectional thickness 128 that begins at the inner surface 120 and extends to the outer surface 118. The pore size progressively changes across the cross-sectional thickness 128. Although the pore size can either progressively increase or decrease across the cross-section zone 128, the pore size often progressively decreases. Across the cross-section zone, for example, the pore size (diameter) often varies in a range from 10 to 100 nanometers but there can be pores having a larger diameter such as up to 500, up to 1000, up to 5000, or even up to 10,000 nanometers.

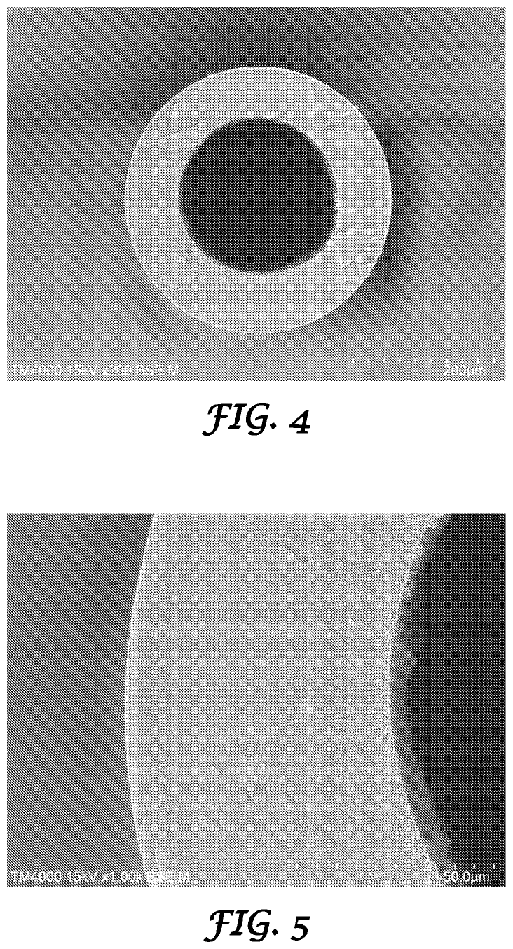

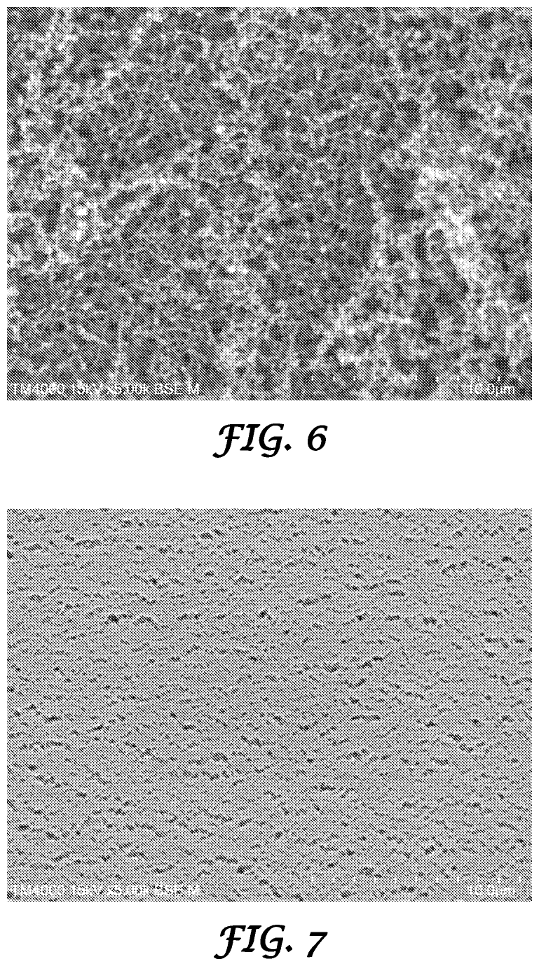

FIG. 4, FIG. 5, FIG. 6, and FIG. 7 are scanning electron micrographs of an exemplary the hollow fiber membrane that was formed in Hollow Fiber Membrane Example 1 (HFM1) as described below. FIG. 4 and FIG. 5 show cross section of the hollow fiber membrane at different magnifications,

FIG. 6 shows the lumen wall of the hollow fiber membrane, and FIG. 7 shows the outside wall of the hollow fiber membrane. The hollow fiber membrane is porous across its width, but the size and shape of the pores vary across the diameter of the membrane.

The membranes described herein, which are typically prepared using POLY-1 and POLY-2, are advantageous compared to previously known membranes. POLY-1, as described above, is a copolymer that is often prepared by reacting a first macromer of Formula (I) having grafted polymeric sidechains of formula R².

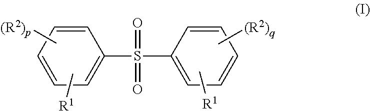

with a second monomer of Formula (IV)

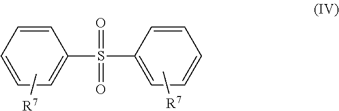

having two functional groups R⁷ that are either nucleophilic groups or leaving groups. The reaction product is typically a copolymer with repeat units connected via an —O— group. Thus, the copolymer has a plurality of groups R², which are grafted polymeric sidechains formed from ethylenically unsaturated monomers.

In many embodiments, the first macromer of Formula (I) is of Formula (I-A) and/or (I-B)

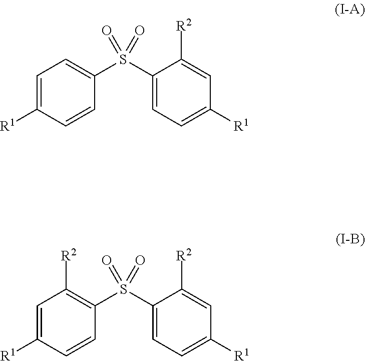

and the second monomer of Formula (IV) is of Formula (IV-C) and/or (IV-D).

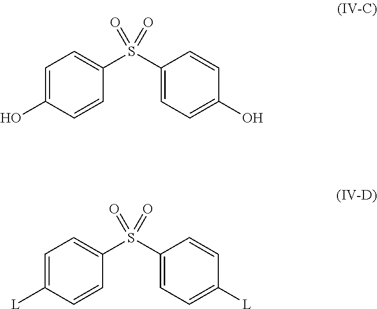

A mixture of (IV-C) and (IV-D) is often used. The resulting copolymer often has first repeat unit of Formula (II-A) and/or Formula (II-B)

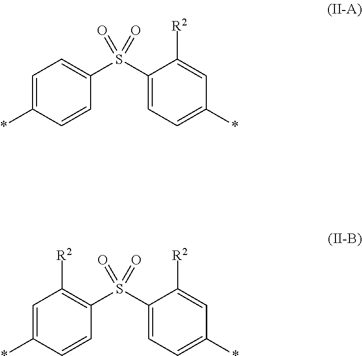

and second repeat unit of Formula (III-A).

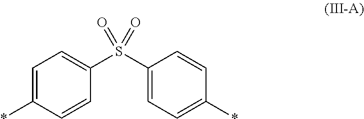

An asterisk (*) is the attachment site to an —O— group that joins two repeat units.

The structural features of POLY-1 can be modified and controlled. For example, both the molecular weight and graft density of the polymeric sidechains can be controlled via stoichiometry during synthesis. Further, the amount of the first macromer used to form POLY-1 can be controlled. This contrasts with other methods where the grafting reaction is performed on a previously formed polymeric material. Thus, the polymeric structure of POLY-1 can be systematically refined to impart desirable characteristics to the membrane such as a particular porosity, pore size, and/or surface hydrophilicity. For example, with respect to fouling resistance versus various bio-foulants (e.g., proteins), detergents, oils, and the like, it is advantageous to optimize the graft density and grafted chain length of the hydrophilic side chains of the copolymer. Resistance to fouling by some foulants may be optimized with short, densely spaced hydrophilic side chains, while resistance to other foulants might best be accomplished with long, more sparsely spaced side chains. With respect to environmentally (e.g., pH) responsive pore size control, the extent of the pore size change effected in response to the environmental stimulus can likewise be controlled through control of the side chain length of the graft copolymer comprising the environmentally responsive side chains. Additionally, graft copolymers comprising side chains themselves comprised of random or block copolymers can affect the environmental response. For example, side chains comprising a random copolymer of two or more pH-responsive repeat units with different pKₐ values can result in pH-responsive filtration characteristics having contributions from each repeat unit type. With the methodology described herein, POLY-1 is purified by conventional synthetic techniques and provided as a solid for direct incorporation into the membrane casting formulations along with POLY-2 and optionally POLY-3.

### Methods of Using the Porous Articles

The porous articles can be used for separating various composition of materials. The macromer of Formula (I) can be chosen to have functional groups that are desirable on the surface of a porous polymeric article such as a membrane. For example, it is often advantageous to select a macromer of Formula (I) that is hydrophilic because the resulting POLY-1 will be amphiphilic and the resulting membrane will be surfaced enriched with POLY-1 during the membrane casting process.

For example, if POLY-1 has grafted sidechains that are poly(methacrylic acid) (PMMA), the sidechains are hydrophilic and facilitate surface enrichment of this grafted copolymer when it is incorporated as a minor component in the casting solution. Further, PMAA is a pH-responsive polymer having a pKₐ of approximately 4.8. Thus, when a membrane having such a POLY-1 is in solution having pH greater than about 4.8, the PMAA side sidechains of the copolymer have negatively charged carboxylate groups that repel one another. This causes the surface enriched PMAA sidechains to swell at high pH, partially blocking the membrane pores and reducing their effective pore size. As pH is decreased below about 4.8, the carboxylate groups of PMAA are increasingly converted to uncharged carboxylic acid groups and the PMAA sidechain dimensions collapse, opening the pores. Thus, surface enriched POLY-1 can be used to create a membrane with a pH-responsive effective pore size. Such a membrane could be useful, for example, for fine-tuning the separation of analytes that are very close in size. Alternatively, for example, such a membrane could be used to perform cation exchange at high pH and then release a bound analyte upon reduction of the pH.

Another exemplary POLY-1 has grafted poly[poly(ethylene glycol) methyl ether methacrylate] [P(PEGMEMA)] sidechains. When enriched at the surface of membranes, these POLY-1 copolymers can render the membranes water wettable in the absence of water-soluble hydrophilic additives (e.g., polyoxazolines, polyvinylpyrrolidone, polyethylene glycols) added to many conventional PES compositions. Unlike those water-soluble additives, these POLY-1 copolymers can be amphiphilic but not water-soluble. Thus, the copolymers can be used to make water-wettable membranes with low extractables. In addition to water wettability, the surface localized P (PEGMEMA) sidechains may also provide resistance to membrane fouling by fluid constituents such as proteins, detergents, or oils. PEGMEMA monomers are commercially available in a variety of molecular weights, enabling the preparation of POLY-1 copolymers with various sidechain molecular weights. Other exemplary POLY-1 copolymers can have side chains comprising anion exchange or cation exchange groups and/or chemical moieties effective for binding particular biomaterials, such as proteins or viruses.

In many embodiments, the porous articles are membranes suitable for separating components of a mixture based on the size of the components. For example, a mixture of biomaterials can be separated based on the size of the various biomaterials in the mixture. The larger biomaterials are typically retained upstream of the membranes and/or pass through (i.e., permeate) the membrane at a slower speed than smaller biomaterials. Thus, the composition exiting the membrane tends to have an enriched concentration of the smaller biomaterials compared to the original mixture of biomaterials.

Thus, a method of separating components based on size is provided. The method includes providing a porous separation article as described above, which is typically a membrane. The method further includes passing a first composition through the membrane, wherein the first composition of biomaterials comprises a plurality of different biomaterials with different average sizes. The method further includes separating the plurality of different biomaterials based on their different average sizes. A first biomaterial that has a smaller average size than a second biomaterial can typically permeate through the membrane more rapidly than the second biomaterial. Likewise, the second biomaterial that has a larger average size than the first biomaterial will be retained by the membrane and/or will permeate through the membrane more slowly than the first biomaterial. Thus, a second composition exiting the membrane will have a higher concentration of the first biomaterial and a lower concentration of the second component compared to the original first composition of biomaterials.

The biomaterials that can be separated include, for example, bacteria, viruses, viral particles, proteins, protein fragments, fusion proteins, cells, and the like. Different size biomaterials within the same general category as well as biomaterials within different general categories can be separated based on their different average sizes. The second composition exiting the membrane will have a higher concentration of the smaller biomaterials.

For example, the membrane can selectively retain viruses or viral particles having a larger average size than other biomaterials in the first composition of biomaterials. Further different size viruses and/or viral particles can be separated from each other with the smaller viruses and/or viral particles permeating though the membrane more quickly. In a specific example, an adeno-associated virus or a portion of an adeno-associated virus can be separated from larger viruses.

Likewise, different bacteria can be separated based on their average sizes with the smaller bacteria permeating through the membrane more quickly or bacteria can be separated from different types of biomaterials based on average size differences.

Similarly, proteins or protein fragments can be separated from other biomaterials. In some examples, the proteins or protein fragments are smaller than the other biomaterials can permeate faster though the membrane. The protein or protein fragment can be, for example, a monoclonal antibody, a monoclonal antibody fragment, or a fusion protein.

The membrane can be used to separate components of a mixture based on a characteristic other than size, or based on a combination of size and another characteristic such as net charge or permeability. The chemical functionality of the side chains of POLY-1 can provide the membrane with the surface chemistry needed for such separations. For example, the membrane might have a surface chemical functionality designed to bind one or more of the components in a solution while allowing other fluid components to pass through the membrane. In yet another example, the membrane might have a positively or negatively charged surface, and this might facilitate either the binding of certain fluid components to the membrane surface or differences in permeability of the membrane with respect to different components of the fluid based in their net charges. In general, any combination of differences in size and other characteristics of two or more fluid components may facilitate differences in the permeability of the membrane with respect to the components.

In some embodiments, the hollow fiber membrane of the present discourse can be used for multiple extracorporeal blood purification procedures including dialysis, blood oxygenation, and plasmapheresis.

### EXAMPLES

Unless otherwise noted or readily apparent from the context, all parts, percentages, ratios, etc. in the Examples and the rest of the specification are by weight.

TABLE 1
Materials Used in the Examples

| | Abbreviation or Trade | |
|---|---|---|
| Reagent | Name | Source |
| 1-Methyl-2-pyrrolidone | NMP-1 | MilliporeSigma |
| 1-Methyl-2-pyrrolidone | NMP-2 | Thermo Fisher Scientific |
| Poly(ethylene glycol) methyl ether | PEGMEMA₄₃ | MilliporeSigma |
| methacrylate, 50 wt % solution in water | | |
| 4,4′-Dimethyl-2,2′-dipridyl | DMDP | MilliporeSigma |
| 2,2′-Bipyridyl | bpy | MilliporeSigma |
| Chlorobenzene, ≥99.5% HPLC | Ph—C1 | Alfa Aesar |
| Potassium ethyl xanthate | EtO(C═S)—S⁻K⁺ | Alfa Aesar |
| t-Butyl methacrylate | tBMA | MilliporeSigma |
| Polyethylene glycol monomethyl ether | PEGMMA 400 | Polysciences |
| monomethacrylate | | (Catalog # 16665) |
| Copper(I) chloride | CuCl | MilliporeSigma |
| Aqueous ammonia | — | MilliporeSigma |
| Methanol | — | VWR |
| N,N-diisopropylethylamine | Hünig's Base, DIPEA | Sigma Aldrich |
| ≥99.5% reagent grade | | |
| Diethyl phosphite 98% | DEP | Sigma Aldrich |
| 4-Fluorobenzenesulfonyl chloride, 98% | No abbreviation | Alfa Aesar |
| 3-Fluorotoluene, 98% | No abbreviation | Tokyo Chemical Industry, |
| | | Alfa Aesar |
| N-bromosuccinimide, 99% | NBS | Sigma Aldrich |
| p-Toluenesulfonic acid monohy drate | TSA | Millipore Sigma |
| Trifluoroacetic acid | TFA | Alfa Aesar |
| 1-Butanol | — | Thermo Fisher Scientific |
| Toluene | PhH | Sigma Aldrich |
| 1,4-Bis(trifluoromethyl)benzene | Hexafluoroxylene, HFX | Sigma Aldrich |
| Methylene chloride-d₂ (D, 99.8%) | CD₂Cl₂, | Cambridge Isotope |
| | deuterodichloromethane, | Laboratories |
| | deuteromethylene chloride | |
| Deuterated chloroform | CDCl₃ | Cambridge Isotope |
| | | Laboratories |
| Deuterated dimethylsulfoxide | DMSO-d₆ | Cambridge Isotope |
| | | Laboratories |
| Hexanes (64% n-hexane) for HPLC, | No abbreviation | Supelco |
| spectrophotometry, and gas | | |
| chromatography | | |
| Sodium hydroxide solution, 10N | 10N NaOH | VWR |
| Acetic acid, glacial | AcOH | VWR |
| Sodium acetate, anhydrous | NaOAc | Thermo Fisher Scientific |
| Tris base buffer | — | Corning |
| Phosphate buffered saline powder | PBS | VWR |
| 4,4′-Sulfonyldiphenol | Bisphenol S | Sigma Aldrich |
| 4,4′-Difluorodiphenylsulfone, 98% | DFDPS | Oakwood Chemical, |
| | | Thermo Scientific |
| Potassium carbonate | K₂CO₃ | Alfa Aesar, Oakwood |
| Polysorbate 80 | TWEEN-80 | VWR |
| Ethyl acetate, HPLC grade | EtOAc | Supelco |
| Hydrochloric acid, ACS Grade | HCl | EMD Millipore |
| Aluminum chloride, anhydrous, 98.5% | AlCl₃ | Thermo Scientific, Acros |
| | | Chemicals |
| Azobisisobutyronitrile, 98% | AIBN | Sigma Aldrich |
| Polyethersulfone | PES, available as | BASF Corp, Florham |
| | ULTRASON E 6020 P | Park, NJ |
| Poly(2-ethyl-2-oxazoline) | PEtOx, available as | Polymer Chemistry |
| | AQUASOL 50 | Innovations, Tucson, AZ |
| Poly(ethylene glycol) 200 g/mol | PEG200, available as | Spectrum Chemical |
| | PO107 | Manufacturing Corp. |
| Copper (I) Bromide | CuBr | Sigma Aldrich |
| Styrene | No abbreviation | Sigma Aldrich |
| N,N,N′,N″,N″- | PMDETA | Sigma Aldrich |
| Pentamethyldiethylenetriamine | | |
| Acetone | No abbreviation | VWR |
| Acryloylmorpholine | No abbreviation | Tokyo Chemical |
| | | Industry |
| Tris[2-(dimethylamino)ethyl]amine | Me6TREN | AMBEED Inc. |
| Basic Alumina | No abbreviation | Sigma Aldrich |

### Test Methods

### GPC Method

Gel permeation chromatography data was obtained using an Agilent 1260 Infinity GPC equipped with isocratic pump, standard degasser, standard autosampler, thermostatted column compartment set to 55 °C, and a refractive index detector using two Agilent PLGel 5 μm Mixed-D 300×7.5 mm gel permeation chromatography columns. Gel permeation chromatography samples were prepared at 5 mg/mL in a solution of 20 mM lithium bromide in N-methylpyrrolidone and then passed over a Pall 0.2 micrometer polypropylene syringe filter. The columns were held at 55 °C and the flow rate was 0.8 mL/min. All molecular weight data are reported against Agilent polystyrene standards (Polystyrene calibration kit S-M-10 part #PL2010-0100).

### NMR Spectroscopy Method 1: Structure Characterization

Nuclear magnetic resonance spectra were obtained using a Bruker Avance III 300 MHz instrument equipped with a room temperature broadband probe or a Bruker Avance III 500 MHz equipped with a broadband cryoprobe. Proton (¹H) spectra were obtained at a 15° pulse angle and a relaxation delay of 4 seconds. Fluorine (¹⁹F) spectra were obtained at a 10° pulse angle, an acquisition time of 2.8 s, and a relaxation delay of 2 seconds.

### Water and Isopropanol Drop Wicking Test

Extracted, dried flat sheet membrane samples were placed on a lightbox. A small drop of water was gently placed on one side of the membrane. If the water drop spontaneously wicked into the film—as evidenced by that spot turning from white and opaque to transparent—the membrane was porous and hydrophilic.

If the water drop beaded up on the surface, a small drop of IPA was gently placed on the other side of the film. If the IPA spread, but did not wick, that side of the membrane was not porous. If the IPA drop wicked into the film, then the membrane was porous and hydrophobic.

### Scanning Electron Microscopy (SEM)

Scanning electron microscopy images were obtained using secondary electron imaging (SEI), which is used to image surface morphology of a sample. Analysis was performed on the Hitachi SU8230 field emission scanning electron microscope (HITACHI, Schaumburg, IL). A low accelerating voltage of 2.0 keV, 10 μA current, and working distance of 3.5-4.5 mm were used. To reduce the likelihood of sample charging and allow for improved imaging, samples were sputter coated with a thin gold/palladium conductive coating prior to analysis.

### PREPARATORY EXAMPLES

### 4-fluoro-1-((4-fluorophenyl) sulfonyl)-2-methylbenzene

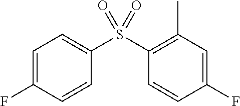 [SMILES: Cc1cc(F)ccc1S(=O)(=O)c1ccc(F)cc1]

To a 2 L 3-neck round bottom flask equipped with a mechanical stirrer, under N₂ atmosphere, 4-fluorobenzenesulfonyl chloride (410.09 g, 2107.2 mmol) followed by 3-fluorotoluene (316.22 g, 2871.3 mmol) were added to the flask. The reaction mixture was heated to 70 °C with a heating mantle and AlCl₃ (315.18 g, 2363.7 mmol) was added portion-wise. After stirring the reaction for 4 hours at 70 °C, the heat was turned off and when the internal temperature had cooled to about 40 °C, 1M HCl (557 mL) was added very slowly to maintain an internal temperature below 90 °C. After complete addition of the HCl solution, the mixture was transferred to a 3 L 3-neck round bottom flask and a reflux condenser was attached. IPA (1 L) was added to the flask and the mixture was warmed to 83 °C until all solids were dissolved. The mixture was allowed to slowly cool to room temperature overnight, under mechanical stirring, to allow for crystallization to happen. The solids were then filtered off and returned to the flask for another two iterations of recrystallizations using 1 L of IPA and 300 ml of water as the recrystallization solvent. Upon drying the solids overnight, 4-fluoro-1-((4-fluorophenyl) sulfonyl)-2-methylbenzene was obtained as a white solid (348.85 g, 61% yield). The recrystallization filtrates contained predominately the 2-fluoro-1-((4-fluorophenyl) sulfonyl)-4-methylbenzene isomer.

Regiochemistry was determined by 2D NMR. ¹H-NMR 4-fluoro-1-((4-fluorophenyl)sulfonyl)-2-methylbenzene (300 MHz, CD₂Cl₂) δ ppm 8.25 (dd, J=8.8, 5.9 Hz, 1H) 7.92 (m, 1H) 7.88-7.90 (m, 1H) 7.20-7.30 (m, 2H) 7.14 (td, J-8.4, 2.6 Hz, 1H) 7.01 (dd, J=9.5, 2.6 Hz, 1H) 2.46 (s, 3H). 1H-NMR 2-fluoro-1-((4-fluorophenyl) sulfonyl)-4-methylbenzene (500 MHz, CD₂Cl₂) δ ppm 8.01-8.07 (m, 1H) 7.97 (t, J=7.8 Hz, 1H) 7.21-7.28 (m, 2H) 7.18 (d, J=8.1 Hz, 1H) 6.99 (s, 1H) 6.97 (s, 1H) 2.42 (s, 3H).

### 2-(Bromomethyl)-4-fluoro-1-(4-fluorophenyl)sulfonyl benzene

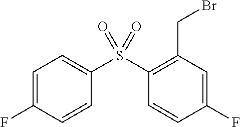 [SMILES: O=S(=O)(c1ccc(F)cc1)c1ccc(F)cc1CBr]

To a 500 mL 3-neck round bottom flask equipped with a mechanical stirrer was added 49.91 g 4-fluoro-1-(fluorophenyl) sulfonyl-2-methyl-benzene (186.0 mmol, 1 equivalent), 51.22 g NBS (279.1 mmol, 1.50 equivalents), 3.38 g AIBN (20.2 mmol, 0.11 equivalents) and 186 mL chlorobenzene. The reaction mixture was heated to 85-96 °C and maintained in this temperature range for 21 hours. The reaction mixture was cooled to 43 °C and 12.88 g DEP (93.26 mmol, 0.50 equivalents) and 4.93 g DIPEA (38.1 mmol, 0.20 equivalents) were added to the reaction and the temperature was maintained at 50 °C for 2 hours before cooling to room temperature. The solids were filtered and the reaction mixture concentrated under reduced pressure. The product was isolated by recrystallization from isopropanol to give 50.0 g of 2-(bromomethyl)-4-fluoro-1-(4-fluorophenyl) sulfonyl benzene as an off-white solid in 77% yield.

¹H NMR (300 MHz, DICHLOROMETHANE-d₂) δ ppm 8.23 (dd, J=8.8, 5.5 Hz, 1H) 7.88-8.03 (m, 2H) 7.17-7.40 (m, 4H) 4.87 (s, 2H).

### O-Ethyl S-(5-fluoro-2-((4-fluorophenyl)sulfonyl)benzyl)carbonodithioate

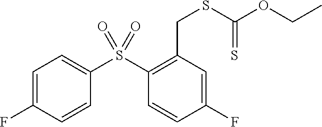 [SMILES: CCOC(=S)SCc1cc(F)ccc1S(=O)(=O)c1ccc(F)cc1]

A solution of 2-(bromomethyl)-4-fluoro-1-(4-fluorophenyl) sulfonyl benzene (694 mg, 2.00 mmol) dissolved in 20 mL of acetone was treated with potassium ethyl xanthate (320 mg, 2.00 mmol) and the stirred mixture was heated to 60 °C overnight under an atmosphere of nitrogen. The reaction mixture was filtered through a pad of Celite and the filtrate was concentrated under reduced pressure to give a light-yellow syrup. Purification by column chromatography (silica gel, 50-75% CH₂Cl₂/hexanes) gave 693 mg of the title compound as a colorless syrup.

¹H NMR (500 MHz, CHLOROFORM-d) δ ppm 8.20-8.26 (m, 1H) 7.85-7.92 (m, 2H) 7.37 (dd, J=9.4, 2.6 Hz, 1H) 7.19-7.24 (m, 2H) 7.14-7.19 (m, 1H) 4.68 (s, 2H) 4.62 (q, J=7.1 Hz, 2H) 1.40 (t, J=7.1 Hz, 3H) ¹⁹F NMR (471 MHz, CHLOROFORM-d) δ ppm −102.98-−102.76 (m, 1F) −103.26 (tt, J=8.4, 4.6 Hz, 1F).

### Polymer Examples (i.e., Macromer Examples)

### Polymer Example 1 (PE1) poly(t-butyl methacrylate) (PtBMA) Using O-ethyl S-(5-fluoro-2-((4-fluorophenyl)sulfonyl)benzyl)carbonodithioate initiator

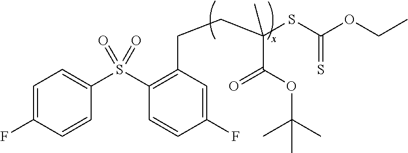

A 4 oz clear glass jar was charged with O-ethyl S-(5-fluoro-2-((4-fluorophenyl) sulfonyl)benzyl) carbonodithioate (80.7 mg, 0.208 mmol). Ethyl acetate (15 mL) and t-butyl methacrylate (5.00 g, 35.2 mmol) were added and the solution was degassed for 15 minutes with a stream of nitrogen. The jar was sealed with a Teflon lined cap and placed on a roller mixer and irradiated for 2 days using a UV lamp (Sylvania F40/350BL black light) placed 5 cm above the jar. The solution was then transferred to a round bottom flask and concentrated under reduced pressure. The resulting syrup was concentrated from toluene under high vacuum at 60 °C to give the 3.44 g as a crusty white solid. NMR analysis indicated that the average molecular weight is approximately 16,500 g/mol.

### Polymer Example 2 (PE2) poly(t-butyl methacrylate) (PtBMA) Using O-ethyl S-(5-fluoro-2-((4-fluorophenyl)sulfonyl)benzyl) carbonodithioate initiator

A 4 oz glass jar was charged with O-ethyl S-(5-fluoro-2-((4-fluorophenyl) sulfonyl)benzyl) carbonodithioate (219 mg, 0.564 mmol). Ethyl acetate (15 mL) and t-butyl methacrylate (5.00 g, 35.2 mmol) were added and the solution was degassed for 15 minutes with a stream of nitrogen. The jar was sealed with a Teflon lined cap and placed on a roller mixer and irradiated for 2 days using a UV lamp (Sylvania F40/350BL black light) placed 5 cm above the jar. The solution was then transferred to a round bottom flask and concentrated under reduced pressure. The resulting syrup was concentrated from toluene under high vacuum at 60 °C to give the 4.33 g as a crusty white solid. NMR analysis indicates that the average molecular weight is approximately 7,600 g/mol.

### Polymer Example 3 (PE3) poly (t-butyl methacrylate)-poly (mPEG 400 methacrylate) (PtBMA-PPEGMMA 400) Random Co Polymer Using O-ethyl S-(5-fluoro-2-((4-fluorophenyl)sulfonyl)benzyl) carbonodithioate initiator

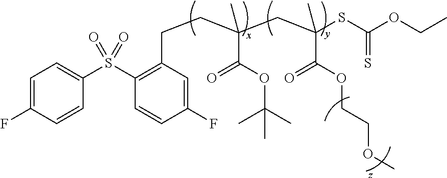

A 4 oz glass jar was charged with O-ethyl S-(5-fluoro-2-((4-fluorophenyl) sulfonyl)benzyl) carbonodithioate (97.0 mg, 0.250 mmol). Ethyl acetate (15 mL), t-butyl methacrylate (1.98 g, 13.9 mmol) and PEG 500 methacrylate (2.09 g, 4.40 mmol) were added and the solution was degassed for 15 minutes with a stream of nitrogen. The jar was sealed with a Teflon lined cap and placed on a roller mixer and irradiated for 2 days using a UV lamp (Sylvania F40/350BL black light) placed 5 cm above the jar. The solution was then transferred to a round bottom flask and concentrated under reduced pressure. The resulting syrup was concentrated from toluene under high vacuum at 60 °C to give the 3.76 g as a crusty white solid. NMR analysis indicates that the average molecular weight is approximately 16,700 g/mol.

### Polymer Example 4 (PE4) poly(t-butyl methacrylate)-poly(mPEG 400 methacrylate) (PtBMA-PPEGMMA 400) Block Co Polymer Using O-ethyl S-(5-fluoro-2-((4-fluorophenyl)sulfonyl)benzyl) carbonodithioate initator

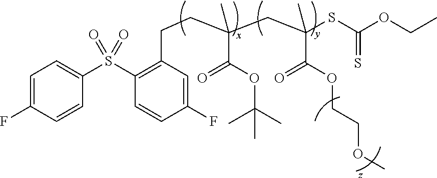

A 4 oz glass jar was charged with O-ethyl S-(5-fluoro-2-((4-fluorophenyl) sulfonyl)benzyl) carbonodithioate (99.7 mg, 0.257 mmol). Ethyl acetate (15 mL) and t-butyl methacrylate (2.03 g, 14.3 mmol) were added, and the solution was degassed for 15 minutes with a stream of nitrogen The jar was sealed with a Teflon lined cap and placed on a roller mixer and irradiated for 24 h using a UV lamp (Sylvania F40/350BL black light) placed 5 cm above the jar. The jar was removed from the roller and treated with PEG 500 methacrylate (2.03 g, 4.28 mmol). The solution was degassed for 15 minutes with a stream of nitrogen and returned to the roller and subjected to UV irradiation for an additional 24 h. The solution was then transferred to a round bottom flask and concentrated under reduced pressure. The resulting syrup was concentrated from toluene under high vacuum at 60 °C to give 4.00 g as a crusty white solid. NMR analysis indicates that the average molecular weight is approximately 16,700 g/mol.

### Polymer Example 5 (PE5) poly(t-butyl methacrylate) (PfBMA) Using 2-(bromomethyl)-4-fluoro-1-(4-fluorophenyl)sulfonyl benzene initiator

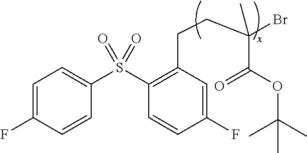

NMP-1 (50 g), tBMA (50 g, 352 mmol, 140 equivalents), 2-(bromomethyl)-4-fluoro-1-(4-fluorophenyl) sulfonyl benzene (0.90 g, 2.51 mmol, 1 equivalent), and DMDP (1.16 g, 6.28 mmol, 2.5 equivalents) were stirred together in a round bottom flask until a homogeneous solution was obtained. The flask was sealed, and the solution was sparged with nitrogen for 10 mins to remove dissolved oxygen. CuCl (0.25 g, 2.51 mmol, 1 equivalent) was then added, after which the flask was re-sealed and the solution was sparged for another 10 mins. Atom transfer radical polymerization (ATRP) was then allowed to proceed for 40 hours at room temperature under a nitrogen blanket. Periodic samples of the reaction mixture were taken by syringe needle during polymerization, dissolved in CDCl₃, and analyzed by ¹H NMR. Conversion was monitored by gradual disappearance of the methacrylate vinyl peaks at 5.7 and 6.0 ppm. After polymerization, the reaction mixture was precipitated in approximately 2 L of a stirred mixture of 4 parts deionized water and 1 part aqueous ammonia to complex copper. The precipitated polymer was stirred in this mixture for 2 hours, then recovered by filtration and dried in air at 115 °C. The dried product was then re-dissolved as an approximately 50 percent by weight solution in NMP-1 and re-precipitated in 2 L of water/aqueous ammonia mixture, then recovered again by filtration and dried in air at 115 °C, yielding 35.6 g of P/BMA macromer as a light green solid (monomer conversion ~70%).

¹H NMR analysis of the product was conducted in CDCl₃: ¹H NMR (300 MHz, CHLOROFORM-d) δ ppm 8.22 (br m, 1H) 7.87 (br m, 2H) 1.83 (br s, 125H) 1.44 (br m, 820H) 1.05 (br m, 250H). The dried macromer contained approximately 0.6 percent by weight NMP-1 by 1H NMR. GPC of the macromer indicated a number-average molecular weight (Mₙ) of 13,029 g/mol, a weight-average molecular weight (M_{w}) of 18,112 g/mol, and a polydispersity index (PDI) of 1.39 with reference to polystyrene standards. The molecular weight of the macromer was also measured by ¹⁹F NMR analysis of a solution composed of a known mass of the product macromer dissolved in a known mass of a standardized solution of HFX in CDCl₃. Measurement of the relative peak integrals of the difluorophenylsulfone peak (−105 ppm) and the hexafluoroxylene peak (−63 ppm) yielded a molecular weight of 17,346 g/mol.

### Polymer Example 6 (PE6) poly(t-butyl methacrylate) (PfBMA) Using 2-(bromomethyl)-4-fluoro-1-(4-fluorophenyl)sulfonyl benzene initiator

NMP-1 (50 g), fBMA (50 g, 352 mmol, 140 equivalents), 2-(bromomethyl)-4-fluoro-1-(4-fluorophenyl) sulfonyl benzene (0.90 g, 2.51 mmol, 1 equivalent), DMDP (1.16 g, 6.28 mmol, 2.5 equivalents), and CuCl (0.25 g, 2.51 mmol, 1 equivalent) were combined and reacted according to the procedure of PE5, except the reaction was allowed to proceed for 70 hours. After polymerization, the reaction mixture was precipitated once in approximately 2 L of a stirred mixture of 4 parts water and 1 part aqueous ammonia, stirred in this mixture for 2 hours, then recovered by filtration and dried in air at 115 °C, yielding 45.0 g of P/BMA monomer as a light green solid (monomer conversion ~88%). Characterization of the macromer was conducted as described in Polymer Example 5. The dried macromer had a GPC molecular weight (polystyrene standards) of Mₙ=14,924 g/mol, M_{w}=17,527 g/mol, PDI=1.17; a ¹⁹F NMR molecular weight of 18,690 g/mol; and contained 2.5 percent by weight NMP-1 by ¹H NMR.

### Polymer Example 7 (PE7) poly(t-butyl methacrylate) (PrBMA) Using 2-(bromomethyl)-4-fluoro-1-(4-fluorophenyl)sulfonyl benzene initiator

NMP-1 (50 g), fBMA (50 g, 352 mmol, 70 equivalents), 2-(bromomethyl)-4-fluoro-1-(4-fluorophenyl) sulfonyl benzene (1.80 g, 5.02 mmol, 1 equivalent), DMDP (2.31 g, 12.6 mmol, 2.5 equivalents), and CuCl (0.50 g, 5.02 mmol, 1 equivalent) were combined and reacted according to the procedure of PE6. After polymerization, the reaction mixture was precipitated once in approximately 2 L of a stirred mixture of 4 parts water and 1 part aqueous ammonia, stirred in this mixture for 2 h, then recovered by filtration and dried in air at 115 °C, yielding 50.0 g of PBMA monomer as a light green solid (monomer conversion ~100%). Characterization of the macromer was conducted as described in Polymer Example 5 (PE5). The dried macromer had a GPC molecular weight (polystyrene standards) of Mₙ=9,181 g/mol, M_{w}=10,635 g/mol, PDI=1.16; a ¹⁹F NMR molecular weight of 10,376 g/mol; and contained 1.0 percent by weight NMP-1 by ¹H NMR.

This example (PE7) demonstrates molecular weight control of the macromer. By doubling the mass proportions of the 2-bromomethyl-4,4′-difluorophenylsulfone initiator, CuCl catalyst, and DMDP ligand relative to fBMA monomer in comparison with PE5 and PE6, the molecular weight of the resulting macromer was roughly halved.

### Polymer Example 8 (PE8) poly(PEGMEMA₄₃) Using 2-(bromomethyl)-4-fluoro-1-(4-fluorophenyl)sulfonyl benzene initiator

PEGMEMA₄₃ had a number-average molecular weight of 2,000 g/mol and was expected to have an average of approximately 43 ethylene glycol repeat units per molecule.

50 percent by weight aqueous PEGMEMA₄₃ solution (140 g of solution, 35 mmol PEGMEMA₄₃ monomer, 10 equivalents), additional deionized water (70 g), methanol (167 g), 2-(bromomethyl)-4-fluoro-1-(4-fluorophenyl) sulfonyl benzene (1.26 g, 3.5 mmol, 1 equivalent), and bpy (1.37 g, 8.75 mmol, 2.5 equivalents) were stirred together in a round bottom flask until a homogeneous solution was obtained. The flask was sealed, and the solution was sparged with nitrogen for 10 mins to remove dissolved oxygen. CuCl (0.35 g, 3.5 mmol, 1 equivalent) was then added, after which the solution was sparged for another 10 mins. The reactor was then sealed and ATRP was allowed to proceed for 41 h at room temperature under a slight nitrogen pressure. Periodic samples of the reaction mixture were taken by syringe needle during polymerization, dissolved in DMSO-d₆, and analyzed by ¹H NMR. Conversion was monitored by gradual disappearance of the methacrylate vinyl peaks at 5.7 and 6.0 ppm.

¹H NMR of the final reaction mixture: ¹H NMR (300 MHz, DIMETHYLSULFOXIDE-d₆) δ ppm 3.51 (br s, 172H), 3.44 (br s, 239H). The polymerization conversion was estimated as 87.7 percent by weight based on the integrals of the NMR vinyl peaks at 5.7 and 6.0 ppm and the ethylene glycol peak at 3.5 ppm. Based on this estimate and the molar quantities of PEGMEMA₄₃ and 2-bromomethyl-4,4′-difluorophenylsulfone present in the reaction, the reaction mixture was estimated to contain 62.67 g of a difluorodiphenylsulfone-endcapped poly (PEGMEMA₄₃) macromer having an average molar mass of 17,905 g/mol [3.50 mmol P (PEGMEMA₄₃) macromer].

### Polymer Example 9 (PE9) poly(styrene) Using 2-(bromomethyl)-4-fluoro-1-(4-fluorophenyl)sulfonyl benzene initiator

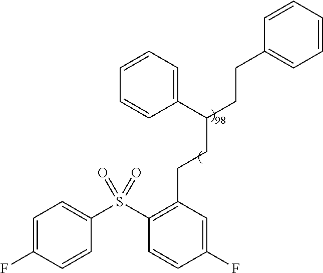 [SMILES: O=S(=O)(c1ccc(F)cc1)c1ccc(F)cc1CCC(CCc1ccccc1)c1ccccc1]

To a 500 mL 2-neck flask equipped with a heating mantle, thermocouple, and J-KEM temperature controller was added styrene (50 g, 480 mmol, 100 equivalents) which had been filtered over 15 g basic alumina, 247 g NMP, and PMDETA (2.51 mL, 12 mmol, 2.5 equivalents) and the solution was sparged with nitrogen for 1 hour. A solution of 244 mg/mL 2-(bromomethyl)-4-fluoro-1-(4-fluorophenyl) sulfonyl benzene in acetone was prepared in a 24 mL vial which had been evacuated and back-filled with nitrogen 5 times using acetone which had been sparged with nitrogen for 1 hour. To the reaction vessel was added CuBr (689 mg, 4.8 mmol, 1 equivalent) followed by the solution of 2-(bromomethyl)-4-fluoro-1-(4-fluorophenyl) sulfonyl benzene (6.83 mL solution, 1.67 g 2-(bromomethyl)-4-fluoro-1-(4-fluorophenylsulfonyl)benzene, 4.8 mmol, 1 equivalent) and the reactant solution was heated at 90 °C for 20.5 hours. The reaction mixture was poured into 2 L methanol, stirred for 4 hours, and the precipitate was collected by filtration and the filter cake washed with 600 mL methanol. The polymer was dried in an oven at 100 °C for 14 hours to give give 23.76 g of white solid in 46% yield. ¹H NMR (500 MHz, CHLOROFORM-d) δ ppm 8.17 (br s, 1H), 7.06 (br m, 288H), 6.53 (br m, 181H), 1.85 (br m, 102H), 1.43 (br s, 182H). The dried macromer had a GPC molecular weight (polystyrene standards) of Mₙ=13,219 g/mol, M_{w}=26,813 g/mol, PDI=2.03.

### Polymer Example 10 (PE10) poly(acryloylmorpholine) Using 2-(bromomethyl)-4-fluoro-1-(4-fluorophenyl)sulfonyl benzene initiator

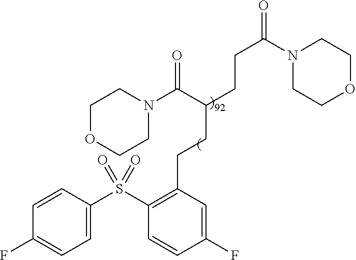 [SMILES: O=C(CCC(CCc1cc(F)ccc1S(=O)(=O)c1ccc(F)cc1)C(=O)N1CCOCC1)N1CCOCC1]

To a 250 mL 3-neck round bottom flask equipped with a mechanical stirrer, vacuum-seal stir bearing, and thermocouple was added acryloylmorpholine (100 g, 708 mmol, 80 equivalents) which had been filtered over 0.3 g basic alumina per gram monomer to remove inhibitor. The monomer was dissolved in 89.8 g water and CuCl (1.05 g, 10.6 mmol, 1.2 equivalents) and Me₆TREN (1.89 mL, 7.08 mmol, 0.8 equivalents) were added. The reactant solution was sparged with nitrogen for 1 hour and cooled to 0 °C. A solution of 226 mg/mL 2-(bromomethyl)-4-fluoro-1-(4-fluorophenyl) sulfonyl benzene in acetone was prepared in a 24 mL vial which had been evacuated and back-filled with nitrogen 5 times using acetone which had been sparged with nitrogen for 1 hour. To the reactant solution was added the 2-(bromomethyl)-4-fluoro-1-(4-fluorophenyl) sulfonyl benzene solution (13.6 mL, 8.85 mmol, 1 equivalent) and the polymerization was allowed to proceed for 30 minutes giving a strong exotherm up to 47 °C within about 1 minute of initiation. The reactant solution was poured into 800 mL MTBE and the biphasic mixture was stirred for 2.5 hours. The top layer was decanted and the viscous bottom layer was dried overnight at 100 °C to give 91.08 g of a green glassy solid in 89% yield. ¹H NMR (500 MHz, DEUTERIUM OXIDE) δ ppm 8.14 (br s, 1H), 7.86 (br s, 2H), 7.34 (br s, 2H), 7.23 (br s, 1H), 7.15 (br s, 1H) 3.53 (br m, 827H), 2.61 (br s, 93H), 1.49 (br m, 181H). The dried macromer had a GPC molecular weight (polystyrene standards) of Mₙ=10,189 g/mol, M_{w}=13,002 g/mol, PDI=1.28.

### Graft Copolymer Examples

### Graft Copolymer Example 1 (GCE1) Polyethersulfone-graft-poly(t-butyl methacrylate) (PES-g-PBMA)

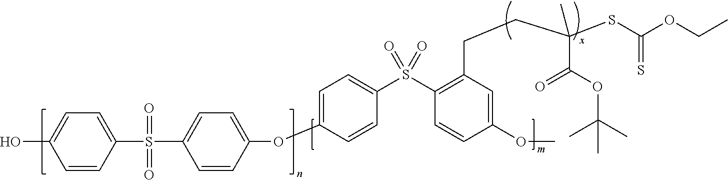

A solution of t-butyl methacrylate polymer (PE1, 3.24 g, 0.197 mmol), 4,4′-sulfonyl diphenol (3.24 g, 12.9 mmol) and bis 4-fluorophenyl sulfone (3.24 g, 12.8 mmol) dissolved in 50 mL of NMP was added to a 500 mL 3-neck round bottom flask. The reaction flask was equipped with a Dean-Stark trap and a reflux condenser. 15 mL of toluene was added to the flask and the mixture was heated 145 °C and stirred under a stream of nitrogen. After 2 hours, the toluene collected in the Dean-Stark trap was removed and an additional 10 mL of toluene was added to the reaction mixture. Heating was continued and the toluene collected in the Dean-Stark trap was removed. The reaction mixture was then treated with K₂CO₃ (4.29 g, 31.1 mmol) and 10 mL of toluene. Heating was continued at 145 °C for 2.5 hours and then lowered to 125 °C and the mixture continued stirring overnight.

The reaction mixture was cooled to about 80 °C and slowly poured into 300 mL of ice-cold deionized water with stirring. A precipitated polymer was isolated by filtration through a Buchner funnel rinsing with water. The collected polymer was stirred with 200 mL of deionized water and again isolated by filtration through a Buchner funnel. Washing with deionized water was repeated two more times. The wet polymer was transferred to a crystallizing dish and allowed to dry to constant weight to give 8.7 g of polymer as a light brown solid. ¹H NMR analysis was performed in d7-DMF and showed that the copolymer contained 34.8 percent by weight poly-tert-butyl methacrylate (PtBMA) and 65.2 percent by weight polyether sulfone (PES). The copolymer had a GPC molecular weight (polystyrene standards) of Mₙ=9.031 g/mol, M_{w}=29,198 g/mol, PDI=3.23.

### Graft Copolymer Example 2 (GCE2) Polyethersulfone-graft-poly(t-butyl methacrylate) (PES-g-PMAA)

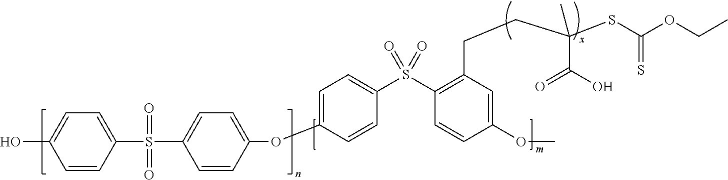

A 4.00 g sample of GCE1 was treated with 20 mL of CH₂Cl₂ and 10 mL of TFA. After stirring for 5 min, all material dissolved to give a blue-green solution. Stirring was continued for 3 h and then the solvent was removed under reduced pressure. The material was stripped with CH₂Cl₂ twice to give a purple-colored film. The material was then suspended in 20 mL of CH₂Cl₂ with rapid stirring. IPA was added (50 mL) causing the polymer to crash out of solution. Stirring was continued for 30 minutes and the material was well dispersed. The solid was isolated by filtration, rinsed with IPA and allowed to air dry in the hood to give 2.41 g of polymer as a light brown solid. ¹H NMR analysis was performed in d7-DMF and showed that the copolymer contained 1.0 percent by weight poly-tert-butyl methacrylate (PtBMA), 24.1 percent by weight poly-methacrylic acid (pMMA) and 75.0 percent by weight polyether sulfone (PES). The copolymer had a GPC molecular weight (polystyrene standards) of Mₙ=9782 g/mol, M_{w}=29,085 g/mol, PDI=2.97.

### Graft Copolymer Example 3 (GCE3) Polyethersulfone-graft-poly(t-butyl methacrylate-poly (mPEG 400 methacrylate) Random copolymer (PES-g-PtBMA/PPEGMMA 400 Random copolymer)

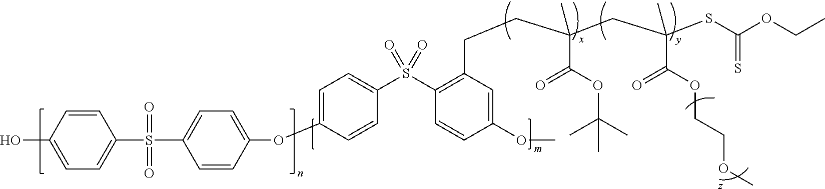

A solution of polymer PE3 (3.76 g, 0.225 mmol), 4,4′-sulfonyl diphenol (3.25 g, 13.00 mmol) and bis 4-fluorophenyl sulfone (3.25 g, 12.77 mmol) dissolved in 50 mL of NMP was added to a 500 mL 3-neck round bottom flask. The reaction flask was equipped with a Dean-Stark trap and a reflux condenser. 15 mL of toluene was added to the flask and the mixture was heated to 145 °C and stirred under a stream of nitrogen. After 2 hours, the toluene collected in the Dean-Stark trap was removed and an additional 10 mL of toluene was added to the reaction mixture. Heating was continued and the toluene collected in the Dean-Stark trap was removed. The reaction mixture was then treated with K₂CO₃ (4.29 g, 31.1 mmol) and 10 mL of toluene. Heating was continued at 145 °C for 2.5 h and then lowered to 125 °C and the mixture continued stirring overnight.

The reaction mixture was cooled to about 60 °C and slowly poured into 400 mL of ice-cold deionized water with stirring. The precipitated polymer was isolated by filtration through a Buchner funnel rinsing with water. The collected polymer was stirred with 200 mL of deionized water and again isolated by filtration through a Buchner funnel. Washing with deionized water was repeated two more times. The wet polymer was transferred to a crystallizing dish and allowed to dry to constant weight to give 8.77 g of polymer as a light brown solid. ¹H NMR analysis was performed in d₇-DMF and showed that the copolymer contained 17.4 percent by weight poly-tert-butyl methacrylate (PtBMA), 18.2 percent by weight polyethylene glycol methacrylate (PEGMA) and 64.4 percent by weight polyether sulfone (PES). The copolymer had a GPC molecular weight (polystyrene standards) of Mₙ=9,973 g/mol, M_{w}=30,788 g/mol, PDI=3.09.

### Graft Copolymer Example 4 (GCE4) Polyethersulfone-graft-poly(methacrylic acid-poly (mPEG 400 methacrylate) Random copolymer (PES-g-PMAA/PPEGMMA 400 Random copolymer)

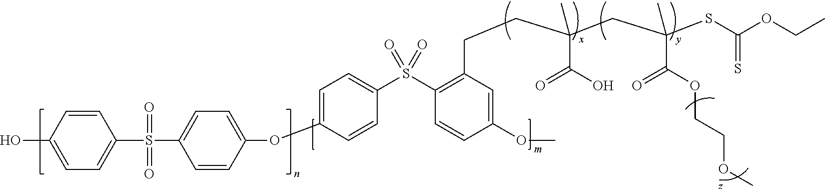

A 4.40 g sample of GCE3 was treated with 20 mL of CH₂Cl₂ and 8 mL of TFA. After stirring for 5 min, all material dissolved to give a blue-green solution. Stirring was continued for 3 hours and then the solvent was removed under reduced pressure. The material was stripped with CH₂Cl₂ twice to give a brown syrup. The material was then treated with IPA (50 mL) and concentrated to give a brown solid. The solid was slurried in hexanes and filtered. The resulting solid was crushed with a spatula into a fine brown powder which was allowed to air dry in the hood to give 3.80 g of the title polymer as a light brown solid. ¹H NMR analysis was performed in d₇-DMF and showed that the copolymer contained 0.9 percent by weight poly-tert-butyl methacrylate (PtBMA), 10.0 percent by weight poly-methacrylic acid (PMMA), 17.3 percent by weight polyethylene glycol methacrylate (PEGMA) and 71.8 percent by weight polyether sulfone (PES). The copolymer had a GPC molecular weight (polystyrene standards) of Mₙ=10,106 g/mol, M_{w}=30,191 g/mol, PDI=2.99.

### Graft Copolymer Example 5 (GCE5) Poly(ether sulfone)-graft-poly(t-butyl methacrylate-poly (mPEG 400 methacrylate) Block copolymer (PES-g-PtBMA/PPEGMMA 400 Block copolymer)

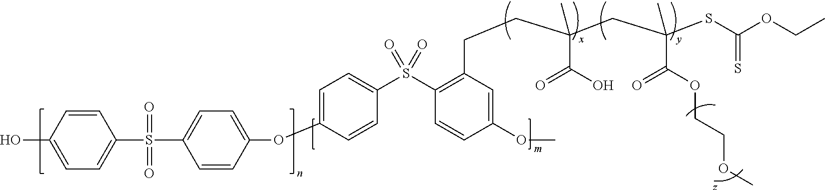

A solution of polymer PE4 (4.00 g, 0.235 mmol), 4,4′-sulfonyl diphenol (3.26 g, 13.02 mmol) and bis 4-fluorophenyl sulfone (3.25 g, 12.77 mmol) dissolved in 50 mL of NMP was added to a 500 mL 3-neck round bottom flask. The reaction flask was equipped with a Dean-Stark trap and a reflux condenser. 15 mL of toluene was added to the flask and the mixture was heated 145 °C and stirred under a stream of nitrogen. After 2 hours, the toluene collected in the Dean-Stark trap was removed and an additional 10 mL of toluene was added to the reaction mixture. Heating was continued and the toluene collected in the Dean-Stark trap was removed. The reaction mixture was then treated with K₂CO₃ (4.29 g, 31.1 mmol) and 10 mL of toluene. Heating was continued at 145 °C for 2.5 hours and then lowered to 125 °C and the mixture continued stirring overnight.

The reaction mixture was cooled to about 80 °C and slowly poured into 400 mL of ice-cold deionized water with stirring. A precipitated polymer was isolated by filtration through a Buchner funnel rinsing with water. The collected polymer was stirred with 200 mL of deionized water and again isolated by filtration through a Buchner funnel. Washing with deionized water was repeated two more times. The wet polymer was transferred to a crystallizing dish and allowed to dry to constant weight to give 8.43 g of polymer as a light brown solid. ¹H NMR analysis was performed in d7-DMF and showed that the copolymer contained 15.5 percent by weight poly-tert-butyl methacrylate (PtBMA), 16.8 percent by weight polyethylene glycol methacrylate (PEGMA) and 67.7 percent by weight polyether sulfone (PES). The copolymer had a GPC molecular weight (polystyrene standards) of Mₙ=8,907 g/mol, M_{w}=23728 g/mol, PDI=2.66.

### Graft Copolymer Example 6 (GCE6) Polyethersulfone-graft-poly(methacrylic acid-poly(mPEG 400 methacrylate) Block copolymer (PES-g-PMAA/PPEGMMA 400 Block copolymer)

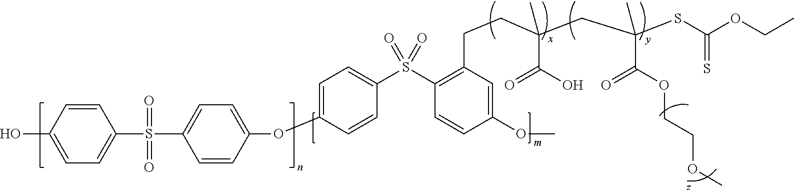

A 4.45 g sample of GCE5 was treated with 20 mL of CH₂Cl₂ and 8 mL of TFA. After stirring for 5 min, all material dissolved to give a blue-green solution. Stirring was continued for 3 h and then the solvent was removed under reduced pressure to give a brown syrup. The syrup was slurried in 50 mL of hexanes to give a solid. The resulting solid was filtered and allowed to air dry in the hood to give 4.35 g of the desired polymer as a light brown solid. ¹H NMR analysis was performed in d7-DMF and showed that the copolymer contained 0.5 percent by weight poly-tert-butyl methacrylate (PtBMA), 8.8 percent by weight poly-methacrylic acid (PMMA), 12.1 percent by weight polyethylene glycol methacrylate (PEGMA) and 78.6 percent by weight polyether sulfone (PES). The copolymer had a GPC molecular weight (polystyrene standards) of Mₙ=8,931 g/mol, M_{w}=23,627 g/mol, PDI=2.65.

### Graft Copolymer Example 7 (GCE7) Polyethersulfone-graft-poly(t-butyl methacrylate) (PES-g-PtBMA)

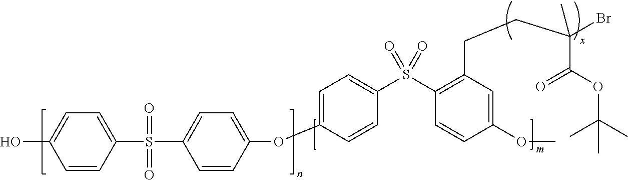

NMP-1 (145 g), PE5 (5.00 g, 0.29 mmol based on its molar mass by ¹⁹F NMR, 0.02 equivalents), bis(4-fluorophenyl) sulfone (3.74 g, 14.7 mmol, 0.98 equivalents), and 4,4′-sulfonyldiphenol (3.76 g, 15.0 mmol, 1 equivalent) were stirred together in a 500-mL 3-neck, round bottom flask until a homogeneous solution was obtained. K₂CO₃ (2.49 g, 18.0 mmol, 1.2 equivalents) and toluene (100 g) were then added to the flask, which was fitted with a magnetic stir bar, heating mantle, thermocouple and temperature controller, Dean-Stark trap, condenser, and nitrogen sparge needle. The reaction mixture was sparged with nitrogen as the temperature was raised to 150 °C. Sparging was continued for 4 hours to azeotropically remove water via the Dean-Stark trap. The remainder of the toluene was then removed via the Dean-Stark trap, after which the nitrogen needle was positioned above the liquid level in the reactor, the reactor was sealed, and reaction was allowed to proceed for 19 hours under a slight positive nitrogen pressure. Conversion was monitored by ¹⁹F NMR of periodic samples of the reaction mixture dissolved in a standardized solution of HFX in DMSO-d₆, wherein gradual disappearance of the difluorophenylsulfone peak (−105 ppm) was observed relative to the HFX peak (−63 ppm). After 19 hours, the nitrogen needle was placed inside the liquid again to sparge the reaction mixture, and the temperature of the reactor was raised to boil off a portion of the NMP-1. The more concentrated reaction mixture was then precipitated in water. The precipitated polymer was recovered by filtration and dried at 115 °C, yielding 8.2 g of dried product as a light tan solid. ¹H NMR was conducted in DMSO-d₆. The copolymer contained 36 percent by weight P/BMA based on the integrals of the PES peak at 8.0 ppm and the t-butyl peak at 1.4 ppm.

### Graft Copolymer Example 8 (GCE8) Polyethersulfone-graft-poly(t-butyl methacrylate) (PES-g-PtBMA)

NMP-1 (216 g), PE5 (19.50 g, 1.12 mmol based on its molar mass by ¹⁹F NMR, 0.015 equivalents), bis(4-fluorophenyl) sulfone (18.11 g, 71.2 mmol, 0.98 equivalents), 4,4′sulfonyldiphenol (18.11 g, 72.3 mmol, 1 equivalent), and K₂CO₃ (12.0 g, 86.8 mmol, 1.2 equivalents) were combined in a 1 L round bottom flask. Azeotropic distillation with toluene (200 g) and polymerization were conducted as described in GCE7. The reaction product was precipitated in water and dried as described in GCE7, yielding 52 g of dried product as a light tan solid (95% of theoretical yield).

¹H NMR was conducted in DMSO-d₆: ¹H NMR (300 MHz, DIMETHYLSULFOXIDE-d₆) δ ppm 8.00 (br d, J=8.44 Hz, 4H) 7.28 (br d, J=8.8 Hz, 4H) 1.38 (br s, 6H) 0.97 (br m, 1H). The copolymer contained 30 percent by weight PtBMA based on the integrals of the PES peak at 8.0 ppm and the t-butyl peak at 1.4 ppm. The copolymer had a GPC molecular weight (polystyrene standards) of Mₙ=41,146 g/mol, M_{w}=93,983 g/mol, PDI=2.28.

### Graft Copolymer Example 9 (GCE9) Polyethersulfone-graft-poly(t-butyl methacrylate) (PES-g-PBMA)

NMP-1 (489 g), PE6 (44.19 g, 2.36 mmol based on its molar mass by ¹⁹F NMR, 0.014 equivalents), bis(4-fluorophenyl) sulfone (41.06 g, 161.5 mmol, 0.98 equivalents), 4,4′sulfonyldiphenol (41.01 g, 163.9 mmol, 1 equivalent), and K₂CO₃ (27.2 g, 196.6 mmol, 1.2 equivalents) were combined in a 2 L cylindrical resin kettle fitted with a 4-neck reactor head, impeller, Dean-Stark trap, condenser, nitrogen sparge tube, thermocouple, temperature controller, and heating mantle. Azeotropic distillation with toluene (300 g) and polymerization were conducted as described in GCE7. The reaction product was precipitated in water and dried as described in GCE7, yielding 112 g of dried product as a light tan solid (89% of theoretical yield).

¹H NMR was conducted in DMSO-d₆. The copolymer contained 29 percent by weight PBMA based on the integrals of the PES peak at 8.0 ppm and the t-butyl peak at 1.4 ppm. The copolymer had a GPC molecular weight (polystyrene standards) of Mₙ=21,928 g/mol, M_{w}=62,917 g/mol, PDI=2.87.

### Graft Copolymer Example 10 (GCE10) Polyethersulfone-graft-poly(methacrylic acid) (PES-g-PMAA)

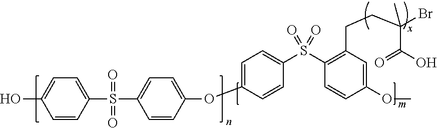

GCE7 (7 g) and TSA (21 g) were dissolved in NMP-1 (77 g) inside a 250-mL 3-neck round bottom flask equipped with a magnetic stir bar, heating mantle, thermocouple, temperature controller, condenser, and nitrogen sparge needle. The solution temperature was raised to 100 °C and the solution was left stirring for 20 hours with nitrogen sparging. The copolymer was precipitated in deionized water, recovered by filtration, and dried in an oven at 115 °C.

¹H NMR was conducted on the dried copolymer: ¹H NMR (300 MHz, DIMETHYLSULFOXIDE-d₆) δ ppm 12.35 (br s, 1H) 8.00 (br m, 4H) 7.28 (br m, 4H) 3.40 (br s, 4H), 1.74 (br m, 3H, overlap with solvent), 0.98 (br m, 3H). Hydrolysis of the t-butyl groups to methacrylic acid was confirmed by disappearance of the t-butyl peak at 1.4 ppm.

### Graft Copolymer Example 11 (GCE11) Polyethersulfone-graft-poly(methacrylic acid) (PES-g-PMAA)

GCE8 (51 g), TSA (51 g), and NMP-1 (250 g) were combined and reacted and the resulting PES-g-PMAA copolymer was recovered and analyzed as described in GCE10.

### Graft Copolymer Example 12 (GCE12) Polyethersulfone-graft-poly(methacrylic acid) (PES-g-PMAA)

GCE9 (112 g), TSA (112 g), and NMP-1 (600 g) were combined and reacted and the resulting PES-g-PMAA was recovered and analyzed as described in GCE10.

### Graft Copolymer Example 13 (GCE13) Polyethersulfone-graft-poly[poly(ethylene glycol) methyl ether methacrylate] [PES-g-P (PEGMEMA₄₃)]

The entire mixture from PE8 was transferred to a 2 L cylindrical resin kettle fitted with a 4-neck reactor head, impeller, Dean-Stark trap, condenser, nitrogen sparge tube, thermocouple, temperature controller, and heating mantle. NMP-1 (693 g) was added to the reactor. While stirring and sparging with nitrogen, the temperature of the mixture was raised to 100 °C to distill off the bulk of the methanol and water, which was removed via the Dean-Stark trap. Distillation was continued for several hours until very little condensate was observed. Toluene (300 g) was then added to the reactor and the temperature was raised to 150 °C to conduct azeotropic distillation of the remaining water until no water was observed in the condensate. The reactor was then cooled to room temperature, after which bis(4-fluorophenyl) sulfone (58.2 g, 228.9 mmol, 0.98 equivalents), 4,4′-sulfonyldiphenol (58.2 g, 232.4 mmol, 1 equivalent), and K₂CO₃ (38.5 g, 278.9 mmol, 1.2 equivalents) were added. The reactor was re-sealed and the temperature was raised again to 150 °C while stirring and nitrogen sparging. Further azeotropic distillation was conducted for 2 h to remove water. The remainder of the toluene was then removed via the Dean-Stark trap, after which the nitrogen needle was positioned above the liquid level in the reactor, the reactor was sealed, and polymerization was allowed to proceed for 20 h under a slight positive nitrogen pressure. ¹⁹F NMR was conducted on the reaction mixture in a standardized DMSO-de solution containing HFX, and substantial completion of the polymerization reaction was confirmed by the absence of a difluorophenylsulfone peak (−105 ppm) relative to the HFX peak (−63 ppm). The reaction mixture was then cooled to room temperature and the product was precipitated in 12 L of deionized water. The solid precipitate was dried in a convection oven at 105 °C, yielding 123 g of PES-g-P (PEGMEMA₄₃) as a brown solid.

¹H NMR of the dried product was conducted in DMSO-d₆: ¹H NMR (300 MHz, DIMETHYLSULFOXIDE-d₆) δ ppm 8.00 (br d, J=7.34 Hz, 4H) 7.28 (br m, 4H) 3.52 (br s, 7H) 3.35 (br s, 2H) 2.70 (br s, 0.58H) 2.18 (br m, 0.37H) 1.91 (br m, 0.38H). The product contained 3.6 percent by weight NMP-1 and the copolymer contained 29 percent by weight P (PEGMEMA₄₃) based on the integrals of the PES peaks at 7.3 and 8.0 ppm, the ethylene glycol peak at 3.5 ppm, and the NMP-1 peak at 1.9 ppm. The copolymer had a GPC molecular weight (polystyrene standards) of Mₙ=18,977 g/mol, M_{w}=45,182 g/mol, PDI=2.38.

### Graft Copolymer Example 14 (GCE14) Poly(ether sulfone)-graft-poly(styrene) (PES-g-PS)

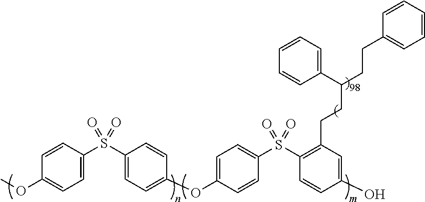

To a 1 L resin kettle equipped with a mechanical stirrer utilizing a teflon stir blade backed by a stainless steel blade, heating mantle, thermocouple attached to a J-KEM temperature controller, ¼″ stainless steel sparge tube, and shortpath distillation head fitted with a 500 mL receiving flask was added 185.6 g NMP, 4,4′-sulfonyldiphenol (46.4476 g, 185.6 mmol, 1 equivalent), 4,4′-difluorodiphenylsulfone (46.6481 g, 183.5 mmol, 0.99 equivalents), poly(styrene) macromer (PE9) (22.8380 g, 2.11 mmol, 0.01 equivalents), potassium carbonate (61.56 g, 445.4 mmol, 2.4 equivalents), and 185.6 g toluene. The reaction mixture was heated to 150 °C and sparged with nitrogen until the toluene had been removed. The temperature was then increased to 165 °C for 4 hours before diluting with 111 g NMP and cooling to room temperature. The reaction mixture was poured into 8 kg deionized water. The precipitate was blended to small pieces in a Waring blender and collected by filtration. The polymer was stirred in 8 kg deionized water for 4 hours, the water exchanged, stirred for 4 more hours, the water exchanged, and stirred overnight before collecting the polymer by filtration and drying at 100 °C overnight to give 103.62 g of off-white solid in 96% yield. NMR samples were prepared by dispersing 20 mg of polymer in DMSO-de with a heat gun followed by cooling to room temperature and diluting with 0.4 mL CDCl₃. ¹H NMR (500 MHz, CHLOROFORM-d) δ ppm 7.03 (br d, J-8.54 Hz, 4H), 6.27 (br d, J=8.39 Hz, 4H), 6.10 (br m, 1.86H), 5.60 (br m, 1.13H), 0.89 (br m, 0.66H), 0.53 (br m, 1.14H). The copolymer had a GPC molecular weight (polystyrene standards) of Mₙ=61,223 g/mol, M_{w}=167,406 g/mol, PDI=2.73.

### Graft Copolymer Example 15 (GCE15) Poly(ether sulfone)-graft-poly(acryloylmorpholine) (PES-g-ACMO)

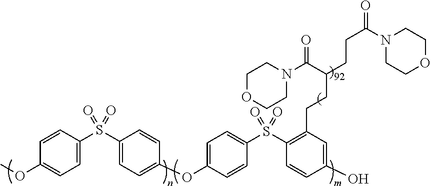

To a 1 L resin kettle equipped with a mechanical stirrer utilizing a teflon stir blade backed by a stainless steel blade, heating mantle, thermocouple attached to a J-KEM temperature controller, ¼″ stainless steel sparge tube, and shortpath distillation head fitted with a 500 mL receiving flask was added 209 g NMP, 4,4′-sulfonyldiphenol (52.3390 g, 209.2 mmol, 1 equivalent), 4,4′-difluorodiphenylsulfone (52.7035 g, 207.3 mmol, 0.99 equivalents), poly(acryloylmorpholine) macromer (PE10) (25.0000 g, 1.84 mmol, 0.01 equivalents), potassium carbonate (69.36 g, 502 mmol, 2.4 equivalents), and 209 g toluene. The reaction mixture was heated to 150 °C and sparged with nitrogen until the toluene had been removed. The temperature was then increased to 165 °C for 4 hours before diluting with 125 g NMP and cooling to room temperature. The reaction mixture was poured into 8 kg deionized water. The precipitate was blended to small pieces in a Waring blender and collected by filtration. The polymer was stirred in 8 kg deionized water for 4 hours, the water exchanged, stirred for 4 more hours, the water exchanged, and stirred overnight before collecting the polymer by filtration and drying at 100 °C overnight to give 110.64 g of grey solid in 91% yield. ¹H NMR (500 MHz, DIMETHYLSULFOXIDE-d₆) δ ppm 8.00 (br d, J=8.70 Hz, 4H), 7.28 (br d, J=8.70 Hz, 4H), 3.44 (br m, 5H, overlap with water), 2.55 (br s, 1H, overlap with solvent), 0.89 (br m, 0.66H), 1.39 (br m, 0.6H). The copolymer had a GPC molecular weight (polystyrene standards) of Mₙ=68,170 g/mol, M_{w}=149,503 g/mol, PDI=2.18.

### Membrane Examples

### Comparative Membrane Example 1 (CMEM-1): Preparation and Wetting Evaluation of a PES Flat Sheet Membrane

A membrane casting dope was prepared containing 17 percent by mass PES, 17 percent by mass 1-butanol, and 66 percent by mass NMP-1. The two liquid components were first added to a 30-mL glass vial with a TEFLON-lined lid, and the resulting solution was homogenized. Then, the PES was added to the vial, after which the vial was sealed and rotated slowly for several hours until the casting dope was homogeneous on a roller table under an infrared heat lamp such that the vial was at a temperature of approximately 50 °C. The casting dope was then allowed to cool to room temperature.

A 4 L beaker was filled with deionized water and placed on a stirring hot plate (RCT Basic S1, IKA Laboratory Equipment, Wilmington, NC) with a temperature controller (ETS-D4 fuzzy, IKA Laboratory Equipment, Wilmington, NC). The water was stirred with a magnetic stir bar while heating to 70 °C. The casting dope was spread on a 10.16 cm (4 in)×25.40 cm (10 in) glass plate using a manual film applicator (BYK-Gardner GmbH, product no. 5357) with a 127-micrometer (0.005 in) gate. Stirring of the 70 °C water bath was then stopped, after which the glass plate was immersed in the water bath, resulting in coagulation of the cast film to form a porous PES membrane. The membrane was left in the water bath until it had fully separated from the glass plate, after which it was removed and placed in a second deionized water bath at room temperature. The membrane was left in the second water bath for at least 1 hour to extract NMP-1 and 1-butanol, after which it was left on a paper towel to dry at room temperature.

After drying, the membrane was evaluated for its water wettability by placing it on a light table with the side that had been the glass-facing side during membrane casting oriented down. A droplet of deionized water was then placed on the upward-facing surface and observed for evidence of wetting of the membrane pores as indicated by translucence of the membrane in the region under the water droplet. The droplet remained rounded and translucence did not appear, indicating the membrane was not water wettable. A droplet of methanol was then placed on the membrane surface and was observed to wet the membrane and become absorbed into its surface. Thus, the membrane was porous but not water wettable. This was expected, as PES membranes are not wettable without the addition of hydrophilic wetting aids.

### Membrane Examples MEM-1 to MEM-8: Preparation and Wetting Evaluation of PES Flat Sheet Membranes Containing PES-g-PMAA Copolymers

Membrane casting dopes were prepared as described in Comparative Membrane Example CMEM-1, with 17 percent by mass 1-butanol and 66 percent by mass NMP-1. Instead of 17 percent by mass PES, however, the dopes contained 17 percent by mass total polymer, of which a portion was GCE10, GCE11, or GCE13 and the balance was PES. The identity of the PES-g-PMAA copolymer and its weight percent as a portion of total polymer for each of the examples is provided in Table 2.

Membranes were cast as described in CMEM-1, with the addition that the pH of the water bath was adjusted to 9 by addition of a small amount of 10N NaOH solution.

After drying, the membranes were evaluated for water wettability as described in CMEM-1. All the membranes were water wettable as indicated by translucence underneath water droplets placed on their surfaces. Translucence was observed to develop and the water droplet was observed to be absorbed by the membranes more quickly as the PES-g-PMAA concentration in the casting dope increased.

### MEM-9 to MEM-12: Preparation and Wetting Evaluation of PES Flat Sheet Membranes Containing GCE13 PES-g-P (PEGMEMA₄₃) Copolymer

Membrane casting dopes were prepared as described in Comparative Membrane Example CMEM-1, with 17 percent by mass 1-butanol and 66 percent by mass NMP-1. Instead of 17 percent by mass PES, however, the dopes contained 17 percent by mass total polymer, of which a portion was PES and another portion was the PES-g-P (PEGMEMA₄₃) copolymer of GCE13. The weight percent of PES-g-P (PEGMEMA₄₃) as a portion of total polymer for each of MEM-9 to MEM-12 is provided in Table 2. Membranes were cast as described in CMEM-1.

After drying, the membranes were evaluated for water wettability as described in CMEM-1. All of the membranes were water wettable as indicated by translucence underneath water droplets placed on their surfaces. Translucence was observed to develop and the water droplet was observed to be absorbed by the membranes within a few seconds for all flat sheet membranes MEM-9 to MEM-12, and more quickly as the PES-g-P (PEGMA₄₃) concentration in the casting dope increased. In comparison with CMEM-1, these examples demonstrate that a PES membrane can be rendered water wettable by addition of PES-g-P (PEGMA₄₃), an amphiphilic but water-insoluble copolymer, with no other wetting agents in the casting dope.

TABLE 2
Casting Dope Composition Details for Comparative Membrane
Examples CMEM-1 and Membrane Examples MEM-1 to MEM-12

| Example | Copolymer | Wt % of Copolymer | |
|---|---|---|---|
| No. | Additive | with respect to Total Polymer | Wettable |
| CMEM-1 | — | — | No |
| MEM-1 | GCE10 | 5.0 | Yes |
| MEM-2 | GCE10 | 10.0 | Yes |
| MEM-3 | GCE10 | 15.0 | Yes |
| MEM-4 | GCE10 | 20.0 | Yes |
| MEM-5 | GCE11 | 5.0 | Yes |
| MEM-6 | GCE11 | 10.0 | Yes |
| MEM-7 | GCE11 | 15.0 | Yes |
| MEM-8 | GCE11 | 20.0 | Yes |
| MEM-9 | GCE13 | 5.0 | Yes |
| MEM-10 | GCE13 | 10.0 | Yes |
| MEM-11 | GCE13 | 15.0 | Yes |
| MEM-12 | GCE13 | 20.0 | Yes |

pH-Responsive Permeability Measurements of MEM-1 to MEM-3: PES Flat Sheet Membranes Containing PES-g-PMAA

100 mM acetic acid solution was prepared by dissolving 12.07 g of glacial acetic acid in deionized water to make 2 L of solution. 100 mM sodium acetate solution was prepared by dissolving 16.46 g of sodium acetate in deionized water to make 2 L of solution. Both solutions were sterile filtered (NALGENE RAPID-FLOW Sterile Disposable Bottle Top Filter with 0.2-micron PES Membrane, Thermo Fisher Scientific Product No. 595-4520).

The inlet tubing for system pump A of a preparative chromatography system (ÄKTA avant 25, Cytiva Item No. 28930842) was immersed in the 100 mM acetic acid solution. The inlet tubing for system pump B was immersed in the 100 mM sodium acetate solution. The “A” and “B” tubing lengths were then filled with the corresponding solutions. Using the gradient function of the ÄKTA to mix the “A” and “B” fluids in various proportions by selecting the portion of the total flow drawn from the “B” fluid (“% B”), it was then possible to deliver to a column position of the ÄKTA a selected flow rate of a mixture of 100 mM acetic acid solution and 100 mM sodium acetate solution having a pH that could vary between approximately 2.7 and 7.5. Fluid was passed through a column position of the ÄKTA at 1 mL/min and 2 mL/min, and the pressure drop across the column position was recorded at each flow rate as the “blank pressure drop” for that column position.

A 25-mm diameter circle of a flat sheet membrane (selected from MEM-1 to MEM-3) was mounted in a polycarbonate filter housing comprising upstream and downstream threaded portions that screw together to restrain the membrane between an o-ring and a support grid of the lower housing portion, providing an effective filtration area of 2.84 cm². The membrane was mounted such that the side facing the water bath during membrane casting was facing the upstream portion of the housing. The upstream portion of the housing was attached to a column position of the ÄKTA. Either 0% B or 100% B was selected initially using the gradient function, and the capsule was vented by delivering the selected solution to the upstream portion of the housing at 1 mL/min with a vent in the upstream housing portion open. Once all air had been removed from the upstream part of the housing, the vent was closed, and the housing was turned upside-down to vent air from the bottom portion of the housing. Once all air had been vented, the downstream portion of the housing was connected to the downstream tubing of the column position on the ÄKTA. The selected fluid was then delivered to the filter housing at a constant flow rate of either 1 or 2 mL/min while monitoring the pH of the fluid downstream of the filter housing using the pH probe of the ÄKTA and monitoring the pressure drop across the membrane column position (“deltaC pressure”). Flow was continued until the pH stabilized at a constant value, whereupon the gradient setting (“% B”), flow rate (Q in mL/min), pH, and “deltaC pressure” (psi) were recorded. The previously recorded blank pressure drop at the same flow rate was then subtracted from the “deltaC pressure” to obtain the pressure drop across the membrane housing (DP, psi). The membrane permeability was then calculated using Equation (1).

$$Permeability = [ \frac{L}{{m}^{2} \cdot h \cdot psi} ] = \frac{Q [ mL / min ]}{( 2.84 {cm}^{2} ) ( Δ P [ psi ] )} \times \frac{{100}^{2} {cm}^{2}}{1 {m}^{2}} \times \frac{60 min}{1 h} \times \frac{1 L}{1000 mL} \qquad ( 1 )$$

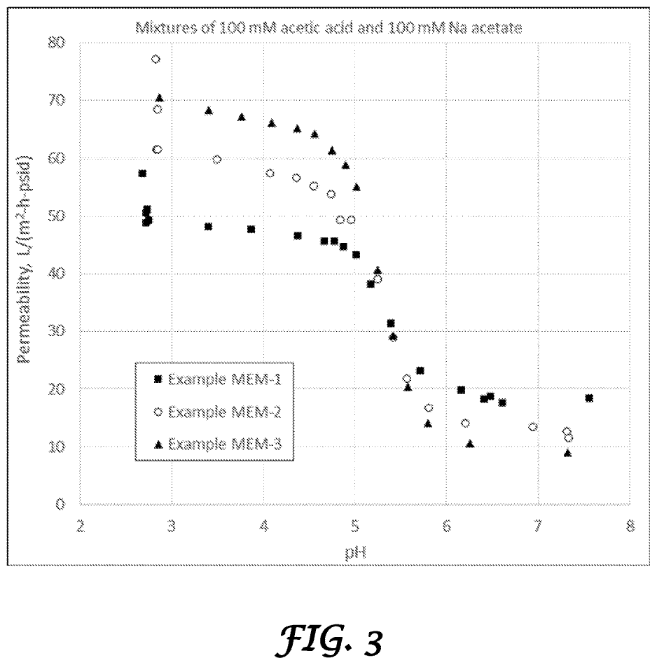

The results for the membranes of MEM-1 to MEM-3 are provided in Tables 3-5, respectively. Plots of membrane permeability as a function of pH appear in FIG. 3. The permeability of the membranes of Examples 11-13, containing PES-g-PMAA copolymers, are highly pH-dependent, and the difference between the permeability under acidic conditions and the permeability under basic conditions increases with increasing PES-g-PMAA content. Proceeding from low pH to high pH, the onset of a rapid transition from high permeability to low permeability occurs at roughly the pKₐ of PMAA of ~4.8. Thus, the pH-responsive nature of the membranes is attributed to expansion of the negatively charged polyanionic PMAA chains at pH>pKₐ and the contraction of the PMAA chains as the carboxylates are hydrogenated and neutralized as pH decreases below pKₐ.

TABLE 3
pH-Responsive Permeability Testing Results
for MEM-1 (5 wt % PES-g-PMAA)

| Condition | Gradient | Q | | DP | Permeability |
|---|---|---|---|---|---|
| Time Order | % B | (mL/min) | pH | (psi) | (L/m²-h-psi) |
| 1 | 0% | 1 | 2.69 | 3.7 | 57.2 |
| 2 | 100% | 1 | 6.41 | 11.6 | 18.2 |
| 3 | 0% | 1 | 2.73 | 4.2 | 50.4 |
| 4 | 100% | 1 | 6.49 | 11.4 | 18.6 |
| 5 | 0% | 1 | 2.75 | 4.3 | 49.2 |
| 6 | 0% | 2 | 2.74 | 8.3 | 51.0 |
| 7 | 100% | 2 | 7.56 | 23.1 | 18.3 |
| 8 | 90% | 2 | 5.40 | 13.5 | 31.4 |
| 9 | 95% | 2 | 5.72 | 18.4 | 23.0 |
| 10 | 98% | 2 | 6.17 | 21.5 | 19.7 |
| 11 | 85% | 2 | 5.18 | 11.1 | 38.1 |
| 12 | 80% | 2 | 5.02 | 9.8 | 43.2 |
| 13 | 75% | 2 | 4.88 | 9.5 | 44.6 |
| 14 | 70% | 2 | 4.78 | 9.3 | 45.5 |
| 15 | 65% | 2 | 4.67 | 9.3 | 45.5 |
| 16 | 50% | 2 | 4.38 | 9.1 | 46.5 |
| 17 | 25% | 2 | 3.88 | 8.9 | 47.6 |
| 18 | 10% | 2 | 3.40 | 8.8 | 48.1 |
| 19 | 0% | 2 | 2.73 | 8.7 | 48.7 |
| 20 | 100% | 2 | 6.62 | 24.1 | 17.6 |

TABLE 4
pH-Responsive Permeability Testing Results
for MEM-2 (10 wt % PES-g-PMAA)

| Condition | Gradient | Q | | DP | Permeability |
|---|---|---|---|---|---|
| Time Order | % B | (mL/min) | pH | (psi) | (L/m²-h-psi) |
| 1 | 0% | 2 | 2.84 | 5.5 | 77.0 |
| 2 | 100% | 2 | 6.95 | 31.9 | 13.3 |
| 3 | 0% | 2 | 2.86 | 6.2 | 68.3 |
| 4 | 100% | 2 | 7.32 | 34.0 | 12.5 |
| 5 | 98% | 2 | 6.22 | 30.5 | 13.9 |
| 6 | 95% | 2 | 5.82 | 25.6 | 16.5 |
| 7 | 92% | 2 | 5.58 | 19.6 | 21.6 |
| 8 | 89% | 2 | 5.43 | 14.7 | 28.8 |
| 9 | 85% | 2 | 5.26 | 10.9 | 38.8 |
| 10 | 75% | 2 | 4.97 | 8.6 | 49.2 |
| 11 | 65% | 2 | 4.75 | 7.9 | 53.6 |
| 12 | 55% | 2 | 4.56 | 7.7 | 55.0 |
| 13 | 45% | 2 | 4.37 | 7.5 | 56.4 |
| 14 | 30% | 2 | 4.08 | 7.4 | 57.2 |
| 15 | 10% | 2 | 3.50 | 7.1 | 59.6 |
| 16 | 0% | 2 | 2.85 | 6.9 | 61.3 |
| 17 | 100% | 2 | 7.34 | 37.5 | 11.3 |
| 18 | 70% | 2 | 4.85 | 8.6 | 49.2 |
| 19 | 0% | 2 | 2.86 | 6.9 | 61.3 |

TABLE 5
pH-Responsive Permeability Testing Results
for MEM-3 (15 wt % PES-g-PMAA)

| Condition | Gradient | Q | | DP | Permeability |
|---|---|---|---|---|---|
| Time Order | % B | (mL/min) | pH | (psi) | (L/m²-h-psi) |
| 1 | 100% | 1 | 7.32 | 23.4 | 9.0 |
| 2 | 98% | 1 | 6.26 | 20.1 | 10.5 |
| 3 | 95% | 1 | 5.80 | 15.1 | 14.0 |
| 4 | 92% | 1 | 5.58 | 10.4 | 20.4 |
| 5 | 89% | 2 | 5.42 | 14.5 | 29.2 |
| 6 | 85% | 2 | 5.25 | 10.4 | 40.7 |
| 7 | 77% | 2 | 5.02 | 7.7 | 55.0 |
| 8 | 72% | 2 | 4.90 | 7.2 | 58.8 |
| 9 | 65% | 2 | 4.75 | 6.9 | 61.3 |
| 10 | 55% | 2 | 4.56 | 6.6 | 64.1 |
| 11 | 45% | 2 | 4.37 | 6.5 | 65.1 |
| 12 | 30% | 2 | 4.09 | 6.4 | 66.1 |
| 13 | 17% | 2 | 3.76 | 6.3 | 67.2 |
| 14 | 8% | 2 | 3.40 | 6.2 | 68.3 |
| 15 | 0% | 2 | 2.87 | 6.0 | 70.5 |

### Pressure Drop Measurement of MEM-1 to MEM-3 Containing PES-g-PMAA Copolymers During pH Cycling

25 mM acetic acid solution was prepared by dissolving 3.02 g of glacial acetic acid in deionized water to make 2 L of solution. 25 mM tris base solution was prepared by dissolving 6.06 g of tris base buffer powder in deionized water to make 2 L of solution. Both solutions were sterile filtered (NALGENE RAPID-FLOW Sterile Disposable Bottle Top Filter with 0.2-micron PES Membrane, Thermo Fisher Scientific Product No. 595-4520).

The inlet tubing for system pump A of a preparative chromatography system (ÄKTA avant 25, Cytiva Item No. 28930842) was immersed in the 25 mM tris base solution. The inlet tubing for system pump B was immersed in the 25 mM acetic acid solution. The “A” and “B” tubing lengths were then filled with the corresponding solutions. Fluid was passed through a column position of the ÄKTA at 2 mL/min, and the pressure drop across the column position was recorded as the “blank pressure drop” for that column position.

A 25-mm diameter circle of a flat sheet membrane (selected from MEM-1 to MEM-3) was mounted in a filter housing as described in the pH-Responsive Permeability Measurements above. The upstream portion of the housing was attached to a column position of the ÄKTA. A gradient of 0% B was selected initially, and the capsule was vented by delivering the 25 mM tris base solution to the upstream portion of the housing at 2 mL/min with a vent in the upstream housing portion open. Once all air had been removed from the upstream part of the housing, the vent was closed and the housing was turned upside-down to vent air from the bottom portion of the housing. Once all air had been vented, the downstream portion of the housing was connected to the downstream tubing of the column position on the ÄKTA.

The membrane was challenged at a flow rate of 2 mL/min with a flow that cycled after every 13 mL of throughput between a gradient selection of 0% B and 100% B. Thus, for the beginning half of each cycle, the membrane was challenged with 25 mM tris base. Over 13 mL of throughput, the pH and conductivity readings of the ÄKTA stabilized at 9.3 and 0.1 mS/cm, respectively. For the ending half of each cycle, the membrane was challenged with 25 mM acetic acid, resulting in a gradual reduction in the pH. By the end of the next 13 mL of throughput, the pH and conductivity readings stabilized at 3.6 and 0.3 mS/cm, respectively. At the end of each half-cycle, the “deltaC” pressure drop across the column position on which the membrane housing was installed was recorded, and the “blank pressure drop” of the column position was subtracted from that value to obtain the pressure drop, DP, across the membrane housing. The pH, conductivity, and DP values at the end of each half-cycle were measured for the membranes of MEM-1 to MEM-3 and the test showed reversibility under varying pH values, therefore confirming that the membranes were stable under varying pH environments.

This test illustrates that the pH-responsive permeability behavior of the membranes containing PES-g-PMAA is substantially reproducible over multiple cycles of changing pH conditions.

TABLE 6
Pressure Drop Measurement of MEM-1 During
pH Cycling (5 wt % PES-g-PMAA)

| | Cumulative | | Conductivity, | DP, |
|---|---|---|---|---|
| Cycle No. | Throughput, mL | pH | mS/cm | psi |
| 1.0 | 13 | 9.34 | 0.11 | 125.8 |
| 1.5 | 26 | 3.63 | 0.28 | 72.8 |
| 2.0 | 39 | 9.31 | 0.12 | 139.4 |
| 2.5 | 52 | 3.62 | 0.29 | 67.7 |
| 3.0 | 65 | 9.31 | 0.12 | 140.8 |
| 3.5 | 78 | 3.62 | 0.29 | 67.3 |
| 4.0 | 91 | 9.31 | 0.12 | 142.9 |
| 4.5 | 104 | 3.61 | 0.29 | 67.7 |
| 5.0 | 117 | 9.31 | 0.12 | 144.4 |
| 5.5 | 130 | 3.61 | 0.29 | 68.8 |
| 6.0 | 143 | 9.31 | 0.12 | 141.8 |
| 6.5 | 156 | 3.61 | 0.28 | 66.8 |
| 7.0 | 169 | 9.31 | 0.12 | 139.1 |
| 7.5 | 182 | 3.61 | 0.28 | 67.6 |
| 8.0 | 195 | 9.31 | 0.12 | 140.4 |
| 8.5 | 208 | 3.61 | 0.28 | 68.9 |
| 9.0 | 221 | 9.31 | 0.12 | 141.8 |
| 9.5 | 234 | 3.61 | 0.29 | 69.5 |
| 10.0 | 247 | 9.31 | 0.12 | 142.9 |
| 10.5 | 260 | 3.61 | 0.29 | 70.3 |
| 11.0 | 273 | 9.31 | 0.12 | 143.8 |
| 11.5 | 286 | 3.61 | 0.29 | 71.0 |
| 12.0 | 299 | 9.30 | 0.12 | 144.7 |
| 12.5 | 312 | 3.61 | 0.29 | 71.6 |
| 13.0 | 325 | 9.30 | 0.12 | 145.5 |
| 13.5 | 338 | 3.61 | 0.29 | 72.4 |
| 14.0 | 351 | 9.30 | 0.12 | 147.1 |
| 14.5 | 364 | 3.61 | 0.29 | 73.1 |
| 15.0 | 377 | 9.30 | 0.12 | 147.8 |
| 15.5 | 390 | 3.61 | 0.29 | 73.6 |
| 16.0 | 403 | 9.30 | 0.13 | 149.1 |

TABLE 7
Pressure Drop Measurement of MEM-2 During
pH Cycling (10 wt % PES-g-PMAA)

| | Cumulative | | Conductivity, | DP, |
|---|---|---|---|---|
| Cycle No. | Throughput, mL | pH | mS/cm | psi |
| 1.0 | 13 | 9.40 | 0.10 | 136.1 |
| 1.5 | 26 | 3.63 | 0.28 | 38.4 |
| 2.0 | 39 | 9.36 | 0.11 | 137.9 |
| 2.5 | 52 | 3.62 | 0.29 | 28.9 |
| 3.0 | 65 | 9.36 | 0.11 | 140.5 |
| 3.5 | 78 | 3.62 | 0.29 | 28.2 |
| 4.0 | 91 | 9.36 | 0.11 | 142.7 |
| 4.5 | 104 | 3.62 | 0.29 | 28.5 |
| 5.0 | 117 | 9.36 | 0.11 | 145.0 |
| 5.5 | 130 | 3.62 | 0.29 | 28.9 |
| 6.0 | 143 | 9.36 | 0.11 | 146.2 |
| 6.5 | 156 | 3.61 | 0.29 | 29.7 |
| 7.0 | 169 | 9.36 | 0.11 | 148.3 |
| 7.5 | 182 | 3.61 | 0.29 | 30.6 |
| 8.0 | 195 | 9.36 | 0.11 | 149.8 |
| 8.5 | 208 | 3.61 | 0.29 | 31.3 |
| 9.0 | 221 | 9.35 | 0.11 | 151.8 |
| 9.5 | 234 | 3.61 | 0.29 | 32.0 |
| 10.0 | 247 | 9.36 | 0.11 | 152.9 |
| 10.5 | 260 | 3.61 | 0.29 | 32.6 |
| 11.0 | 273 | 9.35 | 0.11 | 154.7 |
| 11.5 | 286 | 3.61 | 0.29 | 33.1 |
| 12.0 | 299 | 9.35 | 0.11 | 156.0 |
| 12.5 | 312 | 3.61 | 0.29 | 33.9 |
| 13.0 | 325 | 9.35 | 0.11 | 157.1 |
| 13.5 | 338 | 3.61 | 0.29 | 34.3 |
| 14.0 | 351 | 9.35 | 0.11 | 158.3 |
| 14.5 | 364 | 3.61 | 0.29 | 34.9 |
| 15.0 | 377 | 9.35 | 0.11 | 159.5 |
| 15.5 | 390 | 3.61 | 0.29 | 35.5 |
| 16.0 | 403 | 9.35 | 0.11 | 160.7 |

TABLE 8
Pressure Drop Measurement of MEM-3 During
pH Cycling (20 wt % PES-g-PMAA)

| | Cumulative | | Conductivity, | DP, |
|---|---|---|---|---|
| Cycle No. | Throughput, mL | pH | mS/cm | psi |
| 1.0 | 13 | 9.36 | 0.11 | 130.0 |
| 1.5 | 26 | 3.63 | 0.28 | 9.9 |
| 2.0 | 39 | 9.31 | 0.12 | 128.3 |
| 2.5 | 52 | 3.62 | 0.28 | 9.8 |
| 3.0 | 65 | 9.31 | 0.12 | 128.4 |
| 3.5 | 78 | 3.62 | 0.28 | 10.0 |
| 4.0 | 91 | 9.31 | 0.12 | 130.3 |
| 4.5 | 104 | 3.62 | 0.28 | 10.6 |
| 5.0 | 117 | 9.30 | 0.12 | 132.0 |
| 5.5 | 130 | 3.62 | 0.28 | 11.1 |
| 6.0 | 143 | 9.30 | 0.12 | 134.4 |
| 6.5 | 156 | 3.61 | 0.28 | 11.7 |
| 7.0 | 169 | 9.30 | 0.12 | 136.4 |
| 7.5 | 182 | 3.62 | 0.28 | 12.1 |
| 8.0 | 195 | 9.30 | 0.12 | 139.1 |
| 8.5 | 208 | 3.61 | 0.28 | 13.1 |
| 9.0 | 221 | 9.30 | 0.12 | 141.5 |
| 9.5 | 234 | 3.61 | 0.28 | 13.5 |
| 10.0 | 247 | 9.30 | 0.12 | 143.9 |
| 10.5 | 260 | 3.61 | 0.28 | 14.3 |
| 11.0 | 273 | 9.30 | 0.12 | 146.2 |
| 11.5 | 286 | 3.61 | 0.28 | 14.7 |
| 12.0 | 299 | 9.30 | 0.12 | 148.6 |
| 12.5 | 312 | 3.61 | 0.29 | 15.5 |
| 13.0 | 325 | 9.30 | 0.12 | 150.5 |
| 13.5 | 338 | 3.61 | 0.28 | 16.0 |
| 14.0 | 351 | 9.30 | 0.12 | 152.8 |
| 14.5 | 364 | 3.61 | 0.28 | 16.9 |
| 15.0 | 377 | 9.30 | 0.12 | 155.2 |
| 15.5 | 390 | 3.61 | 0.28 | 17.6 |
| 16.0 | 403 | 9.29 | 0.13 | 157.0 |

### Hollow Fiber Membrane Example 1 (HFM1)

A polymer dope, which can also be referred to as a casting solution, was prepared with the following composition: 23.0 weight percent PES, 9.0 weight percent PEtOx, 2.6 weight percent of GCE13, 30.3 weight percent PEG-200, 33.2 weight percent NMP-2, and 2.0 weight percent deionized water. The polymer dope was mixed using a centrifugal mixer (available as SpeedMixer™ from FlackTek) for 15 seconds at 800 rpm, followed by 9.75 minutes at 1200 rpm. The polymer dope was transferred to a hopper, heated to 50 °C, and degassed under a pressure of 200 mbar. The resulting polymer dope was transparent with a brownish tint and was macroscopically homogeneous.

A gear pump (Model H-9000, available from Zenith Pumps, Monroe, NC) was used to pump the polymer dope from the hopper to a spinneret die with an inner channel for a bore liquid and an annular gap for the polymer dope, separated by a needle. The flow path was heated to 50 °C and included a 15 micrometer in-line filter. The spinneret die had an annular gap of 410 micrometers, a needle outer diameter of 300 micrometers, and a needle inner diameter of 150 micrometers. The spinneret die was fixed at a height of 20 cm above an aqueous precipitation bath and was heated to 50 °C. The bore liquid consisted of 50 weight percent PEG-200, 45 weight percent NMP-2, and 5 weight percent deionized water.

The extruded polymer dope fell through a climate-controlled zone with an air temperature of 50 °C and a relative humidity of 89%. Air was blown through the climate-controlled zone to achieve a steam mass flow rate of 3.5 kg/h. The extruded polymer dope then entered an aqueous precipitation bath heated to 50 °C, thereby vitrifying the pore structure of the hollow fiber membrane. The hollow fiber membrane was collected at a line speed of 145 ft/min and wound on a drum.

The resulting hollow fiber membrane bundle was flushed down the lumen volume with approximately 4 L of deionized water, then extracted in water heated to 90 °C for 1 hour, and finally dried at room temperature overnight. The hollow fiber membrane had an inner diameter of 200 micrometers and an average wall thickness of 68 micrometers.

The membrane pore structure was examined using a scanning electron microscope (SEM, HITACHI TM4000Plus, NCI Inc., Brooklyn Park, MN). Cross sections were prepared by freeze fracturing samples under liquid nitrogen. A thin layer of gold was sputter coated on the samples to make them conductive. SEM micrographs of the hollow fiber membrane appear in FIG. 4 to FIG. 7.

### Comparative Hollow Fiber Membrane Example 1 (CHFM1)

A polymer dope was prepared as in HFM1 but with the following composition: 25.5 weight percent PES, 9.0 weight percent PEtOx, 30.3 weight percent PEG-200, 33.2 weight percent NMP, and 2.0 weight percent deionized water. The polymer dope was transferred to a hopper, heated to 50 °C, and degassed at 200 mbar. The resulting polymer dope was transparent with a yellow tint and was macroscopically homogeneous.

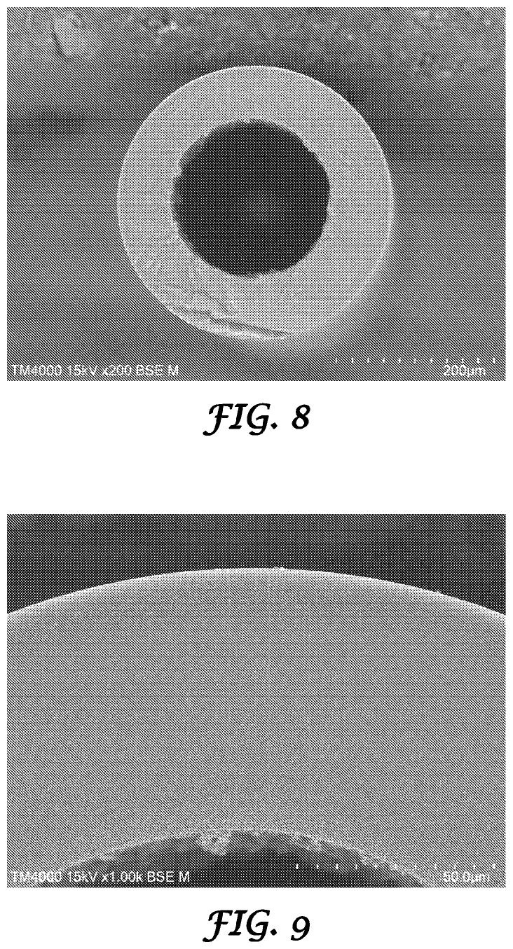

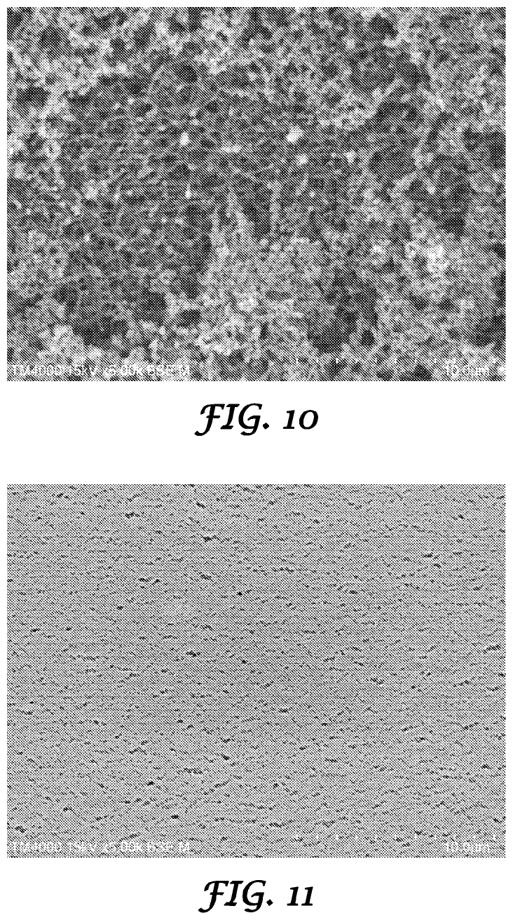

The polymer dope was processed using the same conditions as described in HFM1, resulting in a hollow fiber membrane with an inner diameter of 200 micrometers and an average wall thickness of 72 micrometers. The hollow fiber was imaged by SEM as described for HFM1, and exemplary micrographs appear in FIG. 8 to FIG. 11.

### Fouling Resistance Measurement of Hollow Fiber Membranes

Hollow fiber membrane modules were made containing the hollow fiber membranes of HFM1 and CHFM1. To make each module, two 2.5-inch sections of 0.25 inch nylon tubing (Part No. 2VDL8, Grainger) were cut. The tubing sections were inserted into opposite ends of a polypropylene push-connect T-fitting (Part No. PP0208W-US, John Guest). Three membrane fibers of either Example 25 or Comparative Example C5, each longer than the assembly described above, were passed through the resulting assembly from the open end of one section of nylon tubing to the open end of the opposite section. The open end of each section of nylon tubing was then potted with a roughly ¼-inch plug of epoxy adhesive (LOCTITE EA608, Henkel). The epoxy adhesive was allowed to cure for approximately 20 minutes, after which the plug of epoxy adhesive at each end of the assembly was cut at approximately its halfway point with a razor blade to expose the open ends of the hollow fibers. Each module had a feed inlet at one potted end, a feed outlet at the opposite potted end, and a permeate outlet at the open connection of the T-fitting. The effective filtration area of each module was calculated as the surface area of three cylinders having the length of the membrane module and a diameter equal to the inner diameter of the hollow fiber membrane and had a value of about 2 cm².

PBS buffer solution was prepared by dissolving 1 packet of PBS buffer powder per liter of deionized water. 1 g of TWEEN-80 was added to each liter of a portion of the PBS buffer solution to make a 0.1 weight percent TWEEN-80 solution in PBS buffer. TWEEN-80 is a nonionic detergent, present in some biopharmaceutical cell culture fluids, which is known to foul the surfaces of many filtration membranes. Both solutions were sterile filtered (NALGENE RAPID-FLOW Sterile Disposable Bottle Top Filter with 0.2-micron PES Membrane, Thermo Fisher Scientific Product No. 595-4520).

Flow rate across a hollow fiber module of each type as a function of volumetric throughput was measured at a constant pressure of 2.07 bar (30 psi) while filtering, first, PBS solution, followed by, second, 0.1 weight percent TWEEN-80 in PBS using a PendoTECH NFF Filter Screening System (PendoTECH, Princeton, NJ). The feed inlet of each membrane module was fluidly connected to a 700-mL pressure vessel by an assembly consisting of a Luer stopcock (Part No. EW-12023-27, Cole-Parmer) connected to the pressure vessel, a barbed Luer connector, a segment of ¼-inch tubing, and a polypropylene push-connect union (Part No. PP0408W-US) connected to the membrane module. The feed outlet of each membrane module was connected to an assembly comprising a polypropylene push-connect union, a segment of ¼-inch tubing, a barbed Luer connected, and a Luer cap enabling the feed outlet to be open or closed. The permeate outlet of each membrane module was positioned above a container on a mass balance of the filter screening system. The filter screening system was connected to a computer running software enabling the automated logging of the mass reading on the mass balances every ten seconds.

The stopcock upstream of each membrane module was initially closed, and the pressure vessel upstream of each membrane module was filled with PBS solution. Each pressure vessel was closed and pressurized to 2.07 bar (30 psi) with a compressed air supply and a pressure regulator. The lumens of each hollow fiber module were then vented by opening the Luer cap at the feed outlet and opening the upstream stopcock until buffer was observed exiting the feed outlet. The permeate side of each module was then vented by closing the Luer cap at the feed outlet and observing buffer exiting the permeate outlet. The stopcock upstream of each membrane module was then closed. Automated collection of mass balance readings was then started and the stopcock upstream of each membrane module was opened to initiate flow of PBS buffer solution through both membrane modules. Flow of buffer was allowed to continue for approximately 25 minutes. The stopcock upstream of each module was then closed to stop flow of buffer. Cumulative volumetric throughput (assuming a buffer density of 1 g/mL) was plotted as a function of time for each membrane module, and a linear relationship was observed in both cases. A regression line was fit to each data set, and the slope of the regression line was recorded as the pure buffer flow rate for each membrane module. The pure buffer flow rate for each module was divided by the effective filtration area of each module (2 cm²) and the upstream pressure (2.07 bar) to obtain the pure buffer flux (J_{PBS}) of each membrane module. The pure buffer fluxes of the membrane modules containing the hollow fiber membranes of Example 25 and Comparative Example C5 were 1.86 and 1.66 mL/(cm²-min-bar), respectively.

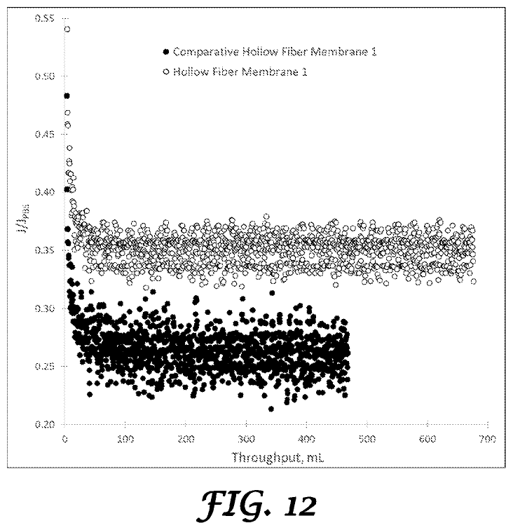

Each of the pressure vessels was then emptied and re-filled with the PBS buffer containing 0.1 weight percent TWEEN-80 as a membrane foulant. The pressure vessels were closed and re-pressurized to 2.07 bar (30 psi). Automated mass logging was re-initiated, and the stopcocks upstream of the membrane modules were opened to initiate flow of the TWEEN-80 solution, which was allowed to continue for 4.3 hours, after which the stopcocks were closed. Data analysis was then conducted to calculate the membrane flux as a function of volumetric throughput (assuming a fluid density of 1 g/mL) for each membrane module. The flow rate at each time point was calculated as the difference in throughput relative to the prior time point divided by the difference in time relative to the prior time point. At each time point, the flux was then calculated by dividing the flow rate by the effective filtration area and the upstream pressure to obtain the membrane flux. A ratio of the membrane flux to the pure buffer flux (J/J_{PBS}) was calculated for each membrane type at each time point. Finally, the data was smoothed by calculating, at each time point, a running average of the seven J/J_{PBS} values centered on that time point. FIG. 12 is a plot of smoothed J/J_{PBS} as a function of volumetric throughput. The initial flux for each membrane was approximately half the pure buffer flux, probably due to the higher viscosity of the TWEEN-80 solution. The flux of each membrane then rapidly decreased during filtration of the TWEEN-80 solution before stabilizing at a lower value. This flux decrease is believed to be due to fouling of the membrane pore structures by adsorption of TWEEN-80. The hollow fiber membrane of HFM1 stabilized at a higher flux than the hollow fiber membrane of CHFM1, which is believed to be due to reduced adsorption of TWEEN-80 on the membrane of HFM1 due to the presence of hydrophilic poly(ethylene glycol) chains of PES-g-P (PEGMEMA₄₃) present at the membrane pore surfaces. This example demonstrates that improved fouling resistance of membranes can be achieved by incorporation of water-insoluble, amphiphilic sulfone copolymers of this invention.

1. A macromer of Formula (I) 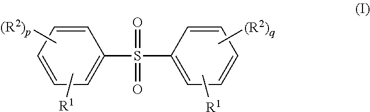
wherein
each R¹ is independently a leaving group or a nucleophilic group;
each R² comprises a grafted polymeric sidechain comprising a plurality of repeat units derived from an ethylenically unsaturated monomer;
p is an integer equal to 0, 1, or 2;
q is an integer equal to 0, 1, or 2; and
p+q is an integer equal to at least 1.

2. The macromer of claim 1, wherein each R¹ is a leaving group selected from —F, —Cl, —Br,
—I, CF₃SO₃—, and —SO₃—C₆H₄—CH₃, or a nucleophilic group selected from —OH and —OSi(R⁶)₃ where each R⁶ is an alkyl.

3. The macromer of claim 1, wherein the ethylenically unsaturated monomer is a vinyl, (meth)acrylate, or (meth)acrylamide monomer.

4. The macromer of claim 1, wherein the grafted polymeric sidechain has 3 to 1000 repeat units derived from the ethylenically unsaturated monomer.

5. The macromer of claim 1, wherein the grafted polymeric sidechain is a homopolymer, random copolymer, or block copolymer.

6. A copolymer comprising a plurality of repeat units joined by —O— groups, wherein the plurality of repeat units comprises:
a) a first repeat unit of Formula (II-A) and/or Formula (II-B) 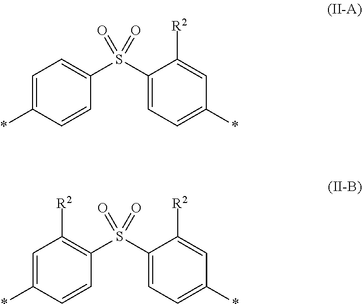
and
b) a second repeat unit of Formula (III-A) 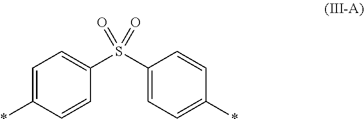
wherein
each R² comprises a grafted polymeric sidechain comprising a plurality of repeat units derived from an ethylenically unsaturated monomer; and
an asterisk (*) is an attachment site to the —O— group that joins two repeat units.

7. The copolymer of claim 6, wherein the plurality of repeat units further comprises a third repeat unit that is different than the first repeat unit and the second repeat unit, wherein the third repeat unit is of Formula (V-A), Formula (V-B), Formula (V-C), Formula (V-D), Formula (VI), or a combination thereof 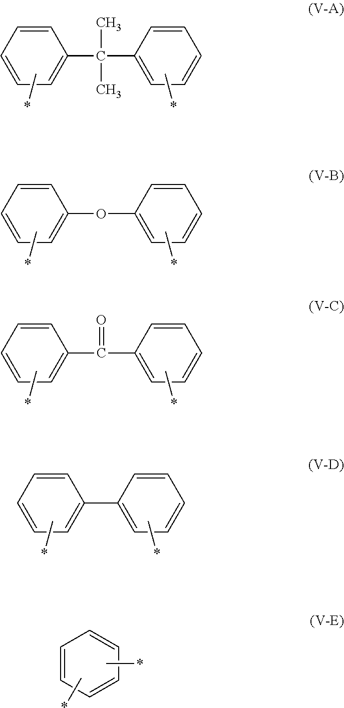
wherein an asterisk (*) is the attachment site to an —O— group that joins repeat units.

8. The copolymer of claim 6, wherein the copolymer comprises 2 to 60 weight percent of the first repeat unit of Formula (II).

9. The copolymer of claim 8, wherein the copolymer comprises 10 to 60 weight percent of the first repeat unit of Formula (II).

10. The copolymer of claim 6, wherein the weight average molecular weight is in a range of 10,000 to 250,000 grams/mole.

11. A porous polymeric article comprising a first copolymer comprising a plurality of repeat units joined by —O— groups, wherein the plurality of repeat units comprises:
a) a first repeat unit of Formula (II-A) and/or Formula (II-B) 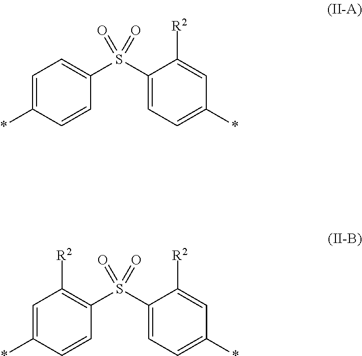
and
b) a second repeat unit of Formula (III-A) 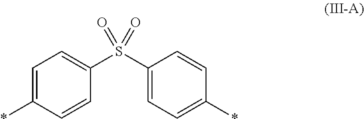
wherein
each R² comprises a grafted polymeric sidechain comprising a plurality of repeat units derived from an ethylenically unsaturated monomer; and
an asterisk (*) is an attachment site to the —O— group that joins two repeat units.

12. The porous polymeric article of claim 11, wherein the porous polymeric article is a membrane comprising 1 to 50 weight percent of the first copolymer and 50 to 99 weight percent of
a second polymer that is an aromatic polyether sulfone having repeat units of Formula (III) 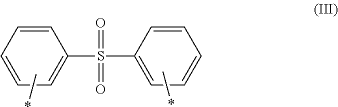
wherein an asterisk (*) is the attachment site to an —O— group that joins two repeat units.

13. The porous polymeric article of claim 12, wherein the second polymer further comprises repeat units of Formula (V-A), Formula (V-B), Formula (V-C), Formula (V-D), Formula (V-E), or a mixture thereof

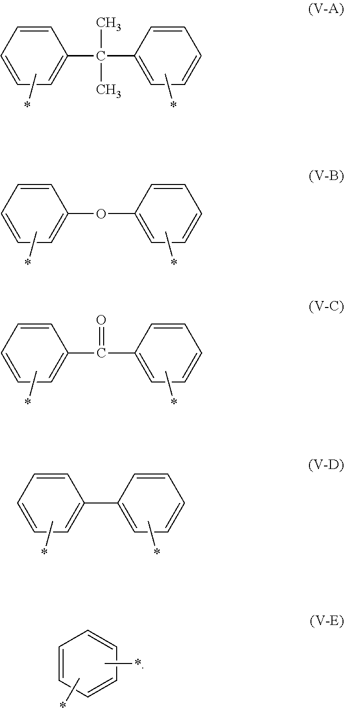

14. The porous polymeric article of claim 12, wherein the membrane is a hollow fiber membrane.

15. A method of separating biomaterials, the method comprising:
providing a porous polymeric article comprising a first copolymer comprising a plurality of repeat units joined by —O— groups, wherein the plurality of repeat units comprises:
a) a first repeat unit of Formula (II-A) and/or Formula (II-B) 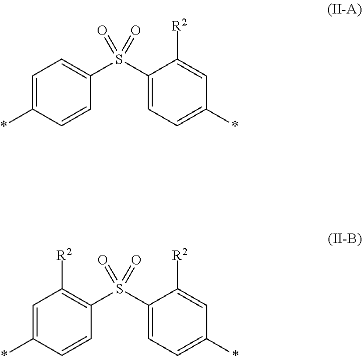
and
b) a second repeat unit of Formula (III-A) 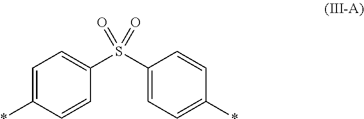
wherein
each R² comprises a grafted polymeric sidechain comprising a plurality of repeat units derived from an ethylenically unsaturated monomer; and
an asterisk (*) is an attachment site to the —O— group that joins two repeat units;
passing an aqueous mixture of biomaterials through the porous polymeric article; and
separating the mixture of biomaterials based on differences in average size, net charge, or permeability of the biomaterials.
